(19) United States
(12) Patent Application Publication
(10) Pub. No.: US 2026/0274064 A1
(43) Pub. Date: Sep. 17, 2026

(54) FUEL TANK SYSTEM

(71) Applicant: ELKHART PLASTICS LLC, Akron, OH (US)

(72) Inventors: Steve Gene BURKHOLDER, Annapolis, MD (US); Paul MIHOJEVICH, Bristol, IN (US); Jacob Mark HIXSON, Portland, OR (US)

(21) Appl. No.: 19/667,878

(22) Filed: May 5, 2026

Related U.S. Application Data
(63) Continuation of application No. PCT/US2024/054944, filed on Nov. 7, 2024.
(60) Provisional application No. 63/596,984, filed on Nov. 8, 2023.

(51) Int. Cl. B60K 15/035; B63H 21/38

(52) U.S. Cl. CPC B60K 15/03519; B63H 21/38; B60K 2015/03528; B60K 2015/03576

(57) ABSTRACT

A fuel system is disclosed. The fuel system includes a tank defining an interior volume, the tank having a neck with an opening in the neck through which the interior volume is accessible. The fuel system also includes a direct fill assembly inserted into the neck of the tank, the direct fill assembly having an upper end and a lower end, wherein the direct fill assembly includes a first venting channel and a second venting channel, the first venting channel extending between the lower end and the upper end and venting gas accumulating proximate to the lower end, the second venting channel connected to an internal venting conduit that extends through the interior volume of the tank and provides venting from a distal end of the internal venting conduit.

### FIELD OF THE DISCLOSURE

This application is a national stage of International Patent Application PCT/US2024/054944, filed 7 Nov. 2024, which claims priority to and the benefit of U.S. Provisional Patent Application No. 63/596,984, filed 8 Nov. 2023, the disclosures of which is are hereby incorporated by reference in their entirety.

### FIELD OF THE DISCLOSURE

The present disclosure relates generally to fuel tank systems and, more particularly, fuel tank systems utilized in marine and boating applications that facilitate venting refilling.

### BACKGROUND OF THE DISCLOSURE

Fuel tanks utilized in marine applications are subject to several regulations and standards due to environmental concerns. For example, boat fuel tanks are required to have a minimum amount of ullage and provide venting of gas fumes from the fuel tank. During operation, the fuel tank may be oriented in various angular attitudes (i.e., bow up and stern down, bow down and stern up, port up and starboard down, and port down and starboard up) and these angular orientations will affect the location of the ullage within the tank and the ability of the fuel tank to vent gas fumes. Nevertheless, regulations require that fuel tanks are able to vent gas fumes regardless of the attitude of the fuel tank. In order to provide proper venting in all attitudes, existing solutions comprise tanks that are designed for being mounted only at certain positions in the boat (e.g., at the bow), but these designs might not be suitable for mounting at other locations in the boat (e.g., at the stern), thereby rendering them unsuitable for all applications. In addition, existing solutions include a lot of external hardware extending outward of the tank, positioned on external surfaces of the tank, and such external hardware present potential leak and break points, and are therefore undesirable.

Accordingly, a need exists for fuel tank systems that can be readily adapted for use with all fuel tank mounting configurations and orientations, and which have less potential for breaking and leaking.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, fuel system includes a tank defining an interior volume, the tank having a neck with an opening in the neck through which the interior volume is accessible. The fuel system further includes a direct fill assembly inserted into the neck of the tank, the direct fill assembly having an upper end and a lower end, wherein the direct fill assembly includes a first venting channel and a second venting channel, the second venting channel extending between the lower end and the upper end and venting gas accumulating proximate to the lower end, the first venting channel connected to an internal venting conduit that extends through the neck and the interior volume of the tank and provides venting from a distal end of the internal venting conduit.

In another embodiment, a method of manufacturing a fuel tank system includes forming a tank with at least one tube holder arranged inside the tank and with an internal venting conduit that extends through a neck of the tank and through the at least one tube holder, connecting a distal end of a conduit to a shutoff valve, inserting the shutoff valve through the neck and into the tank, attaching a clip of the shutoff valve to the internal venting conduit, such that the internal venting conduit and the at least one tube holder support the shutoff valve inside of the tank and couple the shutoff valve to the interior of the tank. The method further includes arranging the direct fill assembly in the neck of the tank and connecting a proximal end of the internal venting conduit to a first venting channel of the direct fill assembly, wherein the direct fill assembly includes an upper end, a lower end, a first venting channel, and a second venting channel, the second venting channel extending between the lower end and the upper end and venting gas accumulating proximate to the lower end, the first venting channel connected to the internal venting conduit that extends through the interior volume of the tank and venting from a distal end of the internal venting conduit.

In a further embodiment, a method of assembling a direct fill assembly includes providing a sleeve of the direct fill assembly and a receiver of the direct fill assembly, installing a venturi sub-assembly in a central bore of the sleeve and installing the receiver in the central bore of the sleeve, wherein the installing the venturi sub-assembly further comprises inserting a lower end of the venturi sub-assembly in an upper end of a lower conduit of the sleeve, such that a passageway extending through a body of the venturi sub-assembly is in communication with and alignment with an inner passageway of the lower conduit. The method further includes installing a fluid limiting float valve in the second venting channel, wherein the second venting channel extends through the sleeve from a top end towards a bottom end, and wherein the installing the fluid limiting float valve in the second venting channel further comprises securing a float in the second channel via a float cap that is inserted into a bottom opening of the second venting channel and retained in the bottom opening via a rivet, installing a check valve on the bottom end of the sleeve, and securing the receiver to the sleeve via a rivet.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an isometric view of a fuel tank system having a direct fill pressure relief assembly, according to one or more embodiments.

FIG. 2A illustrates the direct fill pressure relief assembly of FIG. 1 when removed from the tank and having a check valve in a closed position, according to one or more embodiments.

FIG. 2B illustrates the direct fill pressure relief assembly of FIG. 2A when the check valve is in an open position, according to one or more embodiments.

FIG. 3A illustrates example operation of the system of FIG. 1 when the tank is in a level orientation.

FIG. 3B illustrates example operation of the system of FIG. 1 when the tank is in a stern up orientation.

FIG. 3C illustrates example operation of the system of FIG. 1 when the tank is in a bow up orientation.

FIG. 4A is a top view of the direct fill pressure relief assembly of FIGS. 2A-2B.

FIG. 4B is a side view of the direct fill pressure relief assembly of FIG. 4A.

FIG. 4C is a cross-sectional side view of the direct fill pressure relief assembly along section line FIG. 4C-FIG. 4C in FIG. 4B.

FIG. 4D is a cross-sectional side view of the direct fill pressure relief assembly along section line FIG. 4D-FIG. 4D in FIG. 4A.

FIG. 5 depicts a clip utilized to support an example shutoff valve that is in communication with the direct fill assembly, according to embodiments.

FIG. 6A depicts a cross-section of the fuel tank system taken along an internal venting conduit thereof, according to embodiments.

FIG. 6B depicts a portion of the system identified in FIG. 6A.

FIG. 7 depicts a cross-section of the neck of the tank with the direct fill assembly arranged therein, according to an embodiment.

FIG. 8 depicts an alternate example of a shutoff valve that may be suspended from the clip of FIG. 5.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to fuel tank systems and, more particularly, fuel tank systems utilized in marine and boating applications that facilitate venting refilling. The fuel tank system may include a direct fill pressure relief assembly arranged in a neck of a tank of the fuel tank system. The direct fill pressure relief assembly is configured to permit venting of gas fumes from inside of the tank when the tank is level, when the tank is in a bow end up (and stern end down) orientation, and when the tank is in a stern end up (and bow end down) orientation. Moreover, the direct fill pressure relief assembly permits for venting of the gas fumes through the neck of the tank. The direct fill pressure relief assembly may include a first venting channel and a second venting channel, with the first venting channel connected to an internal venting conduit that extends through the neck and through the inside of the tank to an end of the tank opposite the direct fill pressure relief assembly, and with the second venting channel having a fluid limiting float valve that selectively opens or closes the second venting channel depending on whether fuel is in contact with the direct fill pressure relief assembly. The float valve in the second venting channel closes the second venting channel, inhibiting venting therethrough, when fuel contacts the float valve, for example, when in the bow up (and stern end down) orientation, which would expose the float valve to the fuel. Rather, when in the bow up (and stern end down) orientation, venting would occur through the internal venting conduit and the first venting channel, as a distal end of the internal venting conduit would be positioned at an opposite end of the tank and above the fluid level to thereby provide a means of receiving the gas fumes and allowing such fumes when pressurized to escape through the internal venting conduit and the direct fill pressure relief assembly. However, when the tank is oriented in the stern end up (and bow end down) orientation, while the distal end of the internal venting conduit may be under the fluid level and unable to permit venting through the first venting channel, the direct fill pressure relief assembly will permit venting of gas fumes in the neck of the tank through the second venting channel as the float valve in the second venting channel is above the fluid level such that the float valve is in an open position that allows venting through the second venting channel of gas fumes, including gas fumes located in the neck of the tank. Thus, the direct fill pressure relief assembly vents gas fumes in the neck of the tank via the second venting channel, when the tank is oriented in the stern up orientation and in the level orientation, and the direct fill pressure relief assembly also permits running the internal venting conduit from the neck of the tank, through the interior of the tank to a location in the tank displaced away from the direct fill pressure relief assembly, to thereby permit venting of gas fumes located at such displaced away location out through the direct fill pressure relief assembly situated in the neck of the tank via the internal venting conduit, which extends to the first venting channel through the neck of the tank.

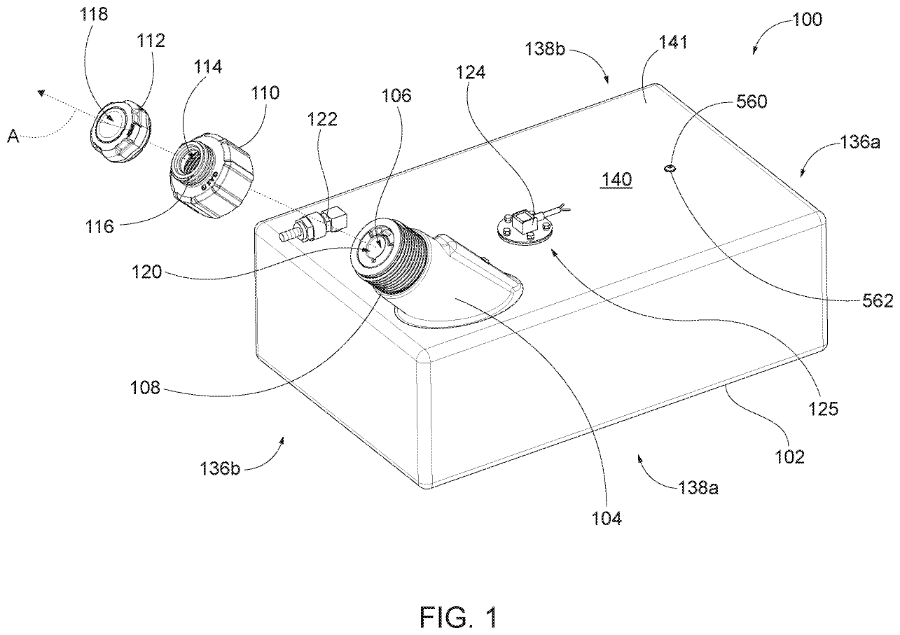

FIG. 1 illustrates a fuel tank system 100, according to one or more embodiments. The fuel tank system 100 (hereinafter, the “system 100”) may be utilized in various types of vehicles or crafts. Thus, while the system 100 is hereinafter described with reference to it being utilized in a watercraft (such as a boat), it may nevertheless be utilized in other types of vehicles, including but not limited to, automobiles, trucks, aircraft, etc.

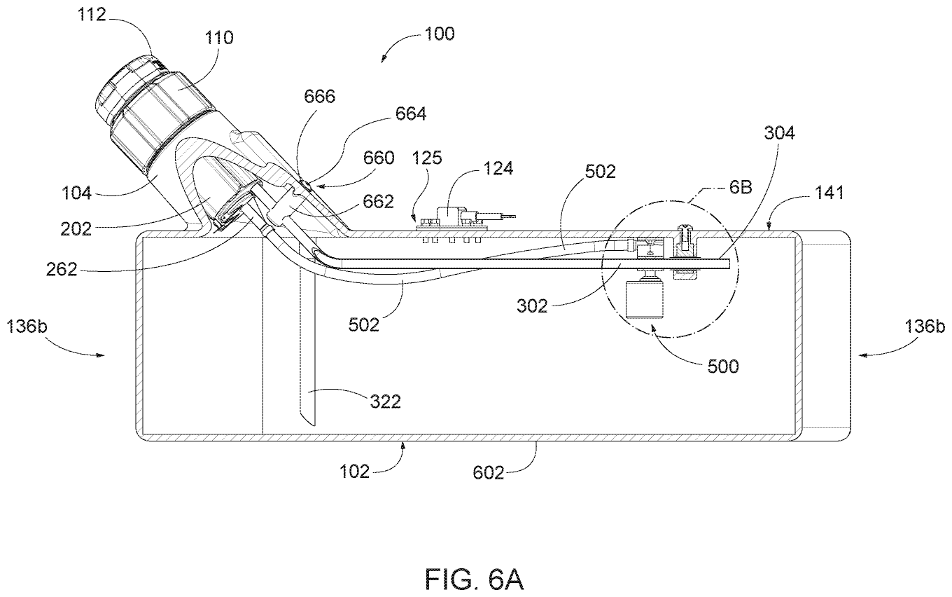

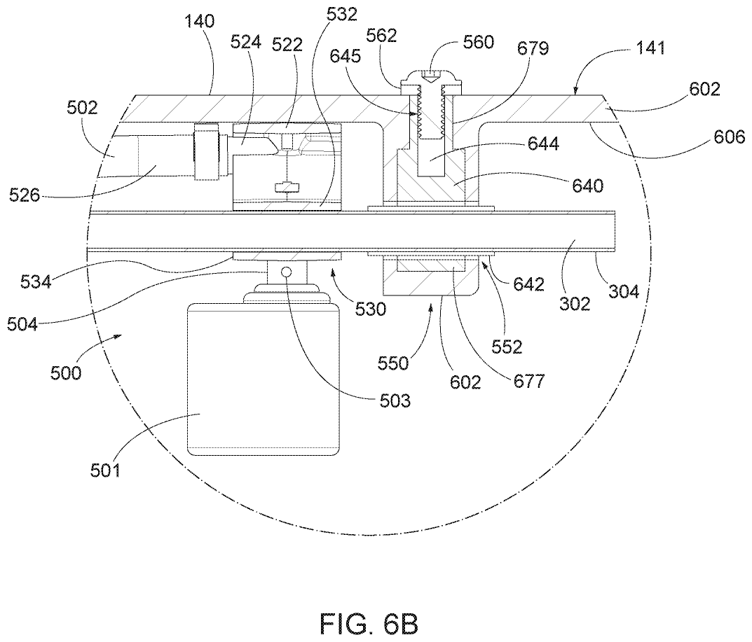

The system 100 includes a tank 102. As best shown in FIGS. 6A-6B, the tank 102 may be formed of a single layer of material 602. In such embodiments, tank 102 may be formed via a molding process/step using the single layer of material 602 to form the tank 102 and the neck 104. The single layer of material 602 may be various types of materials, including a plastic material (e.g., polyethylene) and, in some embodiments, the single layer of material 602 is fluorinated. However, the tank 102 may be differently constructed. For example, the tank 102 could include an inner shell and an outer material that at least partially encapsulates the inner shell, or the tank 102 may be formed of two or more layers of material; and, with either of these alternate examples, the two or more layers of material to assist in enhancing impermeability (i.e., inhibiting permeability) of the tank 102. The tank 102 may be made from various other methods/processes and/or other materials, for example, the tank 102 may be made from a metal material.

The tank 102 includes a bow end 136a and a stern end 136b, and port side 138a and a starboard side 138b. The tank 102 defines an interior volume within which a fluid, such a fuel, may be stored. The tank 102 includes a neck portion 104 extending from the tank 102 along an axis A, and the interior volume of the tank 102 and the contents contained therein may be accessed through the neck 104 when the opening extending through the neck 104 is open or unblocked. In the illustrated embodiment, the neck portion 104 (hereinafter, “the neck 104”) extends from an exterior surface 140 of the tank 102 proximate to the stern side 136b, such that the neck 104 is positioned closer to the stern end 136b than the bow end 136a. Here, the portion of the exterior surface 140 from which the neck 104 extends is an upper surface of the tank 102. However, the neck 104 may be provided elsewhere on the tank 102, for example, closer to the bow end 136a, or may be provided at a central region of the tank 102 that is in between the bow end 136a and the stern end 136b, and in such embodiments, the neck 104 may be positioned closer to the port side 138a than the starboard side 138b, or closer to the starboard side 138b than the port side 138a, or positioned equidistantly in between the port and starboard sides 138a, b. Also in the illustrated example, the neck 104 is positioned closer to the port side 138a than the starboard side 138b, but in other embodiments, the neck 104 may be positioned along a center line of the tank 102 (i.e., equidistantly between the port side 138a and the starboard side 138b) or closer to the starboard side 138b. The neck 104 defines an opening 106 that is in fluid communication with the interior volume of the tank 102 and through which the fluid may be added into the tank 102. In the illustrated embodiment, the neck 104 includes threads 108 at an end of the neck 104. Also, the neck 104 may extend in different orientations than what is illustrated, for example, the neck 104 may extend perpendicular from a top surface of the tank 102, may extend towards either the bow or stern end 136a, b, or may extend toward either side 138a, b. Moreover, while the neck 104 is depicted as extending from and being positioned on a top side/surface of the tank 102, the neck 104 may be arranged on another side/surface of the tank, such as either the side/surface at the bow or stern end 136a, b or the side/surface at the sides 138a, b.

The system 100 also includes an adapter 110 configured to be placed on the neck 104 of the tank 102 and a cap 112 configured to be placed on the adapter 110. The adapter 110 includes threads (not shown) configured to mate with the threads 108 of the neck 104, such that the adapter 110 may be selectively attached or detached from the neck 104 by screwing it on or off. However, other means may be utilized to selectively attach the adapter 110 to the neck 104. The adapter 110 includes an opening 114 that is arranged to align with and communicate with the opening 106 of the neck 104 when the adapter 110 is attached to the neck 104. Also, the adapter 110 includes threads 116 at an end of the adapter 110, and the cap 112 includes corresponding threads (not shown) configured to mate with the threads 116 of the adapter 110, such that the cap 112 may be selectively attached to or detached from the adapter 110 by screwing the cap 112 on or off. However, other means may be utilized to selectively attach the cap 112 to the adapter 110. The cap 112 has a closed end 118 that is effectively seals and closes the opening 114 in the adapter 110 and the opening 106 in the neck 104 when the adapter 110 and the cap 112 are installed. While not illustrated, the cap 112 may include a valve and a tortuous route through which air or gas fumes may be vented out of the tank 102 through the cap 112; however, the cap 112 may be differently configured to allow venting when the cap 112 is attached to the adapter 110.

The system 100 also includes a direct fill pressure relief assembly 120 (hereinafter, the “assembly 120”). As shown, the assembly 120 is provided in the neck 104 of the tank 102. In particular, when the adapter 110 is removed from the neck 104 as shown in FIG. 1, the assembly 120 may be inserted into the opening 108 of the neck 104, such that the assembly 120 extends into and at least partially through the neck 104 along the axis A. The adapter 110 may then be attached to the neck 104 to thereby lock or retain the assembly 120 within the neck 104. Thereafter, the cap 112 may be selectively attached or detached to the adapter 110 to provide access to the internal volume of the tank 102. The assembly 120 is further described below.

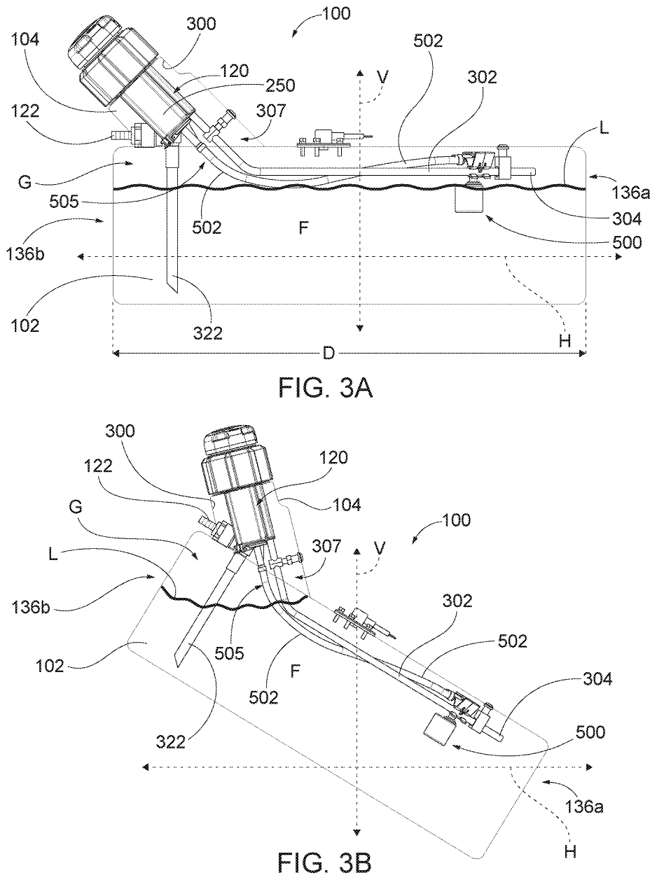

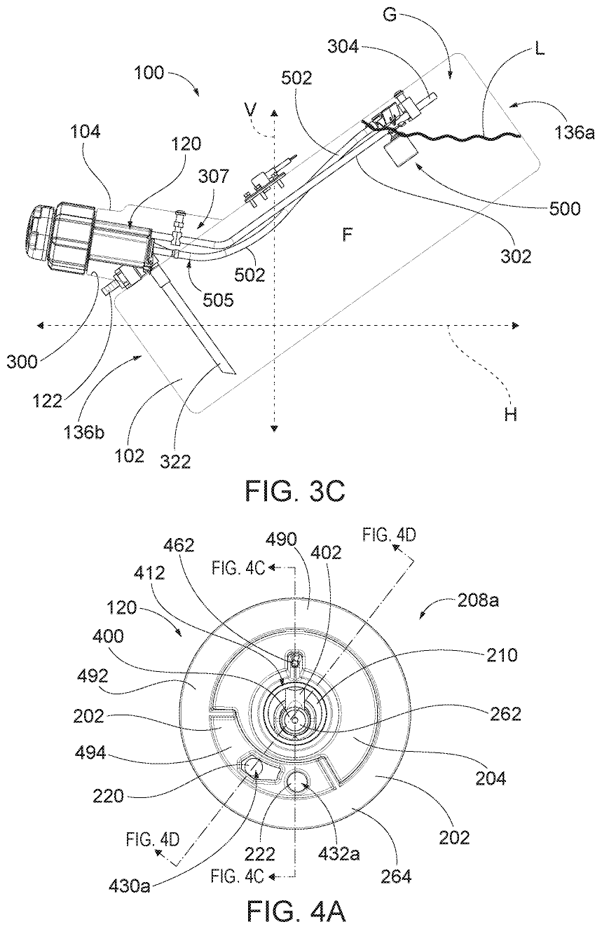

In the illustrated embodiment, the system 100 includes an outlet nozzle 122 provided on the tank 102. The outlet nozzle 122 is a fitting extending outward from the exterior surface 140 of the tank 102. Here, the portion of the exterior surface 140 of the tank 102 upon which the outlet nozzle 122 fitting is installed is an upper surface the tank 102. The system 100 also includes a draw tube 322 (see FIGS. 3A-3C) that is arranged within the interior volume of the tank 102, and extends from and is in fluid communication with the outlet nozzle 122. Thus, fuel may be drawn out of the tank 102 of the system 100 via the outlet nozzle 122 and the draw tube 322 extending therefrom. During use, a fuel input line of the watercraft may be connected to the outlet nozzle 122 and draw fuel, from the interior volume of the tank 102, to the engine of the watercraft via the outlet nozzle 122 and the draw tube 322 in communication therewith.

The system 100 may also include various fittings and components configured to be integrated with other systems of the watercraft (e.g., boat), for example, to monitor one or more characteristics of the tank 102 and/or the fuel contained within the interior volume thereof. In the illustrated embodiment, the system 100 includes a sensor 124 configured to measure fluid level L (see FIGS. 3A-3C) within the tank 102. The sensor 124 may thus have a sensing component that extends into the interior volume of the tank and is operable for detecting the fluid level L. For example, the sensor 124 may be an ultrasonic sensor or a tower level sensor. During use, the sensor 124 may be connected to the electrical system of the watercraft such that a fluid level indicator on the dashboard or control panel of the watercraft may provide indication as to the fluid level L in the interior volume of the tank 102, based on readings received from the sensor 124. It should be appreciated, however, that the sensor 124 may be different types of sensors and/or one or more additional sensors may be utilized in addition to the sensor 124. Also, as described below, the tank 102 may have an opening 125 over which the sensor 124 is attached, such that the sensing component of the sensor 124 may extend through the opening 125 and into the interior volume of the tank 102. As further detailed below, the opening 125 over which the sensor 124 may be installed may also facilitate installation of various interior components of the system 100 within the tank 102, as the opening 125 will provide an access point through which the installer may position and attach such interior components of the system 100 from within the tank 102, such as various types of tubes or conduits extending from the assembly 120.

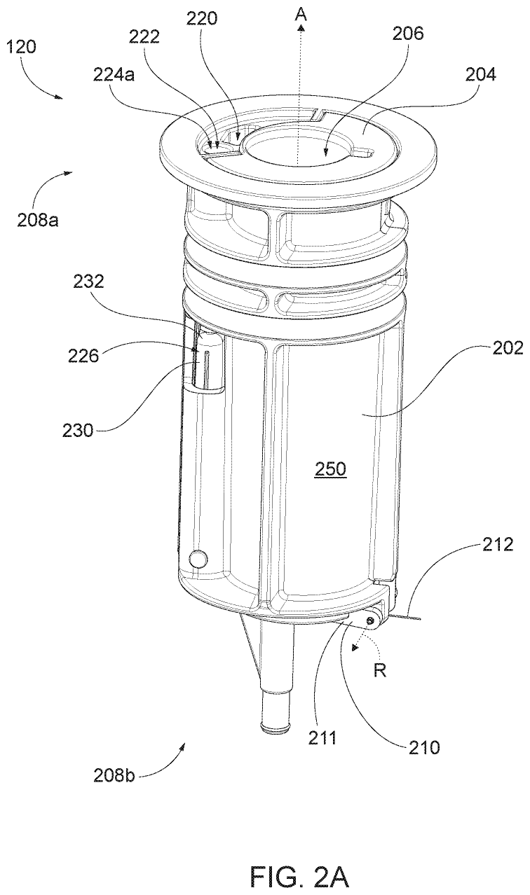

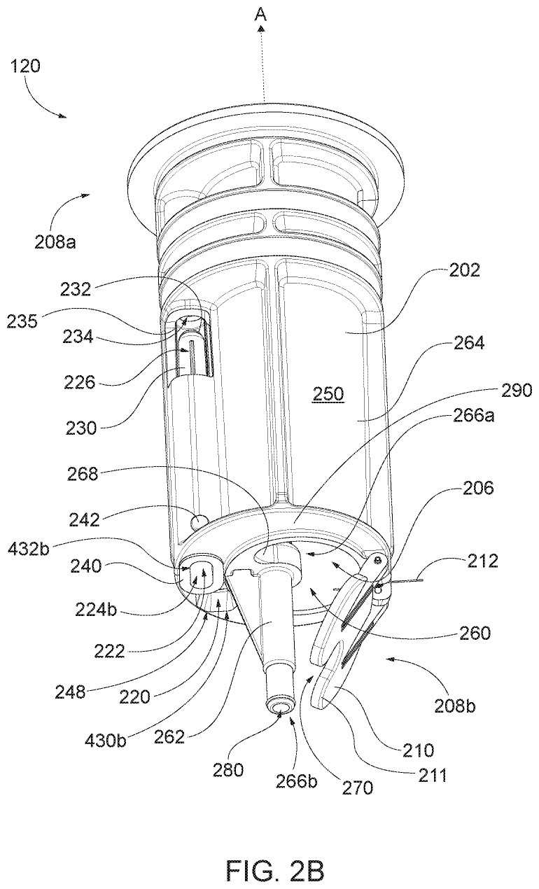

FIGS. 2A and 2B illustrate the assembly 120 when removed/withdrawn from the neck 104, according to one or more embodiments. As shown, the assembly 120 includes a sleeve 202 and a receiver 204 provided within the sleeve 202. The assembly 120 also includes a central bore 206 that extends through the assembly 120, from a top end 208a of the nozzle assembly 120 to a bottom end 208b of the assembly 120, along the axis A. The central bore 206 is configured for receiving an output nozzle of a fuel dispensing nozzle, such that fuel is passed through the central bore 206 of the assembly 120 and into the tank 102. The central bore 206 is at least partially defined by both the sleeve 202 and the receiver 204. For example, the central bore 206 proximate to the top end 208a is defined by a bore of the receiver 204 as shown in FIG. 2A, whereas the central bore 206 proximate to the bottom end 208b is defined by a bore of the sleeve 202 as shown in FIG. 2B. More specifically, the central bore 206 extends through the sleeve 202 such that an opening 260 is defined in the sleeve 202 proximate to the bottom end 208b, with the opening 260 being in communication with the central bore 206. Stated differently, the sleeve 202 includes a bore within which the receiver 204 is inserted, and the receiver 204 includes a bore within which the fuel dispensing nozzle may be inserted during refilling operations, with the central bore 206 being defined by the bore of the receiver 204 proximate to the top end 208a and with the central bore 206 being defined by the bore of the sleeve 202 proximate to the bottom end 208b.

The assembly 120 is configured such that the central bore 206 is closed when fluid is not being dispensed into and through the central bore 206. In the illustrated example, the assembly 120 includes a check valve 210 that is operable to open or close the opening 260 to the central bore 206. Here, the check valve 210 is a flapper valve having a flap 211 that is pivotly attached to the sleeve 202 such that it is movable between a closed position (shown in FIG. 2A), where the flap 211 of the flapper valve covers the opening 260, and an open position (shown in FIG. 2B) where the opening 260 is at least partially uncovered by the flap 211, and a biasing member 212 is provided to bias the flap 211 of the check valve 210 into the closed position shown in FIG. 2A. In the illustrated embodiment, the biasing member 212 is a leaf spring provided about an axis of rotation R of the check valve 210. Thus, the check valve 210 is normally closed (due to the biasing of the biasing member 212) such that, when the cap 112 is off (i.e., when the cap 112 is removed from the adapter 110 and the tank 102) and tank 102 is tilted in a manner that orients the neck 104 downward, the check valve 210 will be closed and inhibit fluid (i.e., fuel) from leaking out through the central bore 206. Also, because the check valve 210 is biased towards/into the closed position, it will increase pressure within a flow chamber of the assembly 120 which is beneficial when receiving fluids at lower flow rates. For example, when the fuel dispensing nozzle is inserted into the central bore 206 of the assembly 120 and discharging fuel at a relatively low flow rate that is insufficient to overcome the biasing force applied by the biasing member 212 on the flap 211, such closure of the flap 211 will allow the amount/volume of fuel within the assembly 120 to build up and thereby generate back pressure, which will increase as more fuel is input into the assembly 120, and which will increase the force that is being exerted against the flap 211 until such back pressure overcomes the biasing force of the biasing member 212 and thereby allows opening of the flap 211. As described below, the assembly 120 is configured to automatically shut off the dispensing nozzle (i.e., inhibit further discharging of fuel from the dispensing nozzle), utilizing Venturi principles, and this back pressure will ensure that the assembly 120 is operable to automatically shut off the dispensing nozzle even at low flow rates. Thus, not only does the check valve 210 inhibit leaking of fluid contained within the interior volume of the tank 102 back out through the neck 104, but the biasing of the check valve 210 creates/generates a back pressure such that the assembly 120 is responsive through a full range of flow rates, rather than just high flow rates.

When fluid is injected/input into the central bore 206 of the assembly 120, the flow of fluid (which is directed from the top end 208a towards the bottom end 208b) may generate sufficient force to overcome the biasing force of the biasing member 212 such that the flap 211 of the check valve 210 will move into the open position shown in FIG. 2B, and the fluid may be dispensed into and enter the interior volume of the tank 102. However, when the assembly 120 is installed in the neck 104 of the tank 102 (as shown in FIG. 1) and when fluid is not being directed into the tank 102 through the assembly 120, the check valve 210 will be closed and thereby effectively block the central bore 206 such that fluid contained in the tank 102 will unable to enter the central bore 206, travel through the assembly 120 (in a direction from the bottom end 208b to the top end 208a) and thereby exit the system 100.

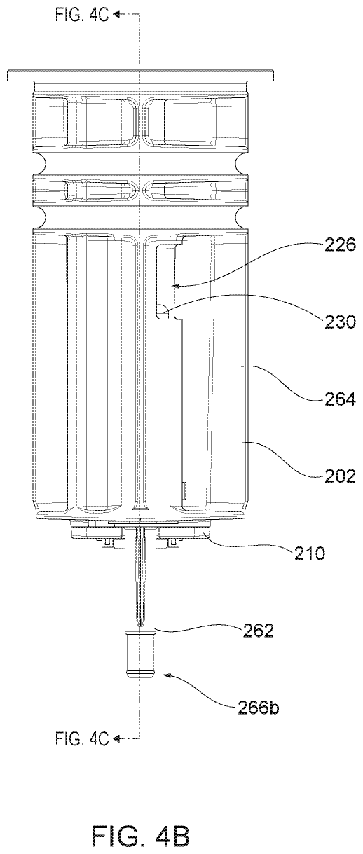

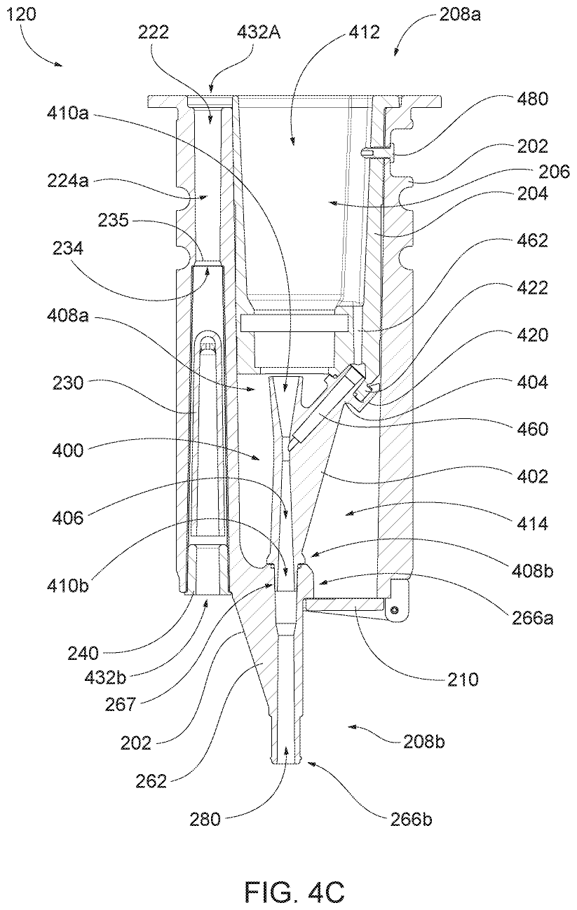

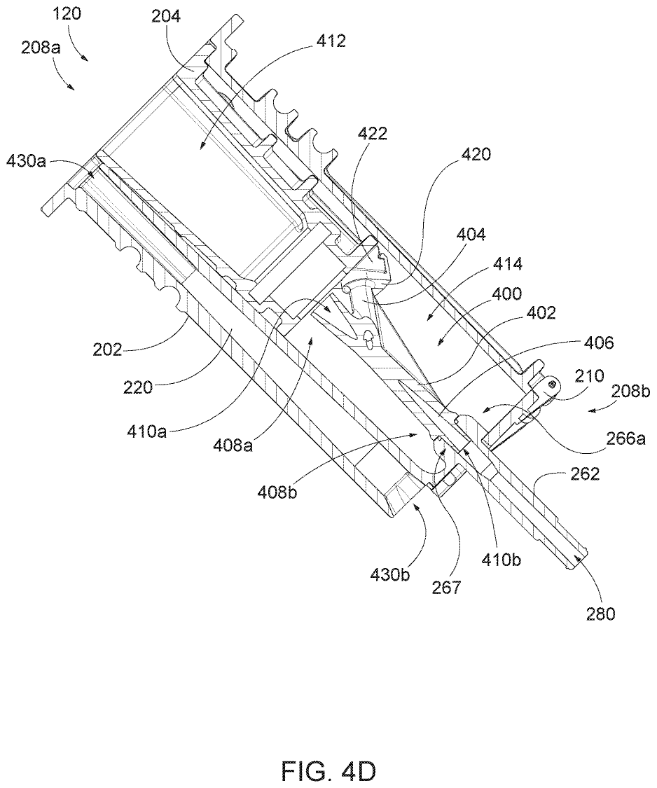

As hereinafter described, the assembly 120 is configured to allow venting of air or gas fumes through the assembly 120 under several different conditions. More specifically, the assembly 120 is configured to allow venting regarding of the attitude or orientation of the tank 102. As shown, the assembly 120 includes a first venting channel 220 and a second venting channel 222. In in the illustrated embodiment, both the first venting channel 220 and the second venting channel 222 extend through the assembly 120, between the top end 208a and the bottom end 208b. In embodiments, the first venting channel 220 and the second venting channel 222 each include an upper opening 430a, 432a (FIG. 4A), respectively, that is located/formed at the top end 208a of the sleeve 202 and a bottom opening 430b, 432b (FIG. 2B) that is located/formed at a midpoint of the sleeve 202 (somewhere between the top 208a and the bottom end 208b). The upper openings 430a, 432a operate as output openings through which gas fumes or air may be vented out of the system 100 and into the ambient environment and the bottom opening 430b of the first venting channel 220 may operate as an input opening for receiving air or gas fumes from the interior of the tank 102. However, the second venting channel 222 may include another/additional opening (e.g., such as a window 226 detailed below) that is located/formed in a portion of the sleeve 202 that is between the upper and lower openings 432a, b thereof, and gas fumes or air from the interior of the tank 102 may enter the second venting channel 222 through the additional opening (e.g., the window 226); and, in these embodiments, the bottom opening 432b may be utilized to install a valve device (e.g., a float 230) in the second venting channel 222 and for causing activation of that valve device to thereby close or open the window 226 (and, thereby, for block or unblock the second venting channel 222) depending on whether the float 230 is exposed to and acted upon by the fluid F in the tank 102, as detailed below.

In the illustrated embodiment, the receiver 202 includes a bottom surface 290 and the bottom openings 430b, 432b are formed in the bottom surface 290 and, in embodiments, the bottom surface 290 is an annular shaped surface that surrounds the central bore 206. In addition, the receiver 202 includes an outer peripheral surface 250 that extends upward from the bottom surface 290 towards a top surface 490 (see FIG. 4A) of the receiver 202. Also in the illustrated embodiment, both the first venting channel 220 and the second venting channel 222 are defined within the sleeve 202 and extend through the sleeve 202, between the upper openings 430a, 432a and the bottom openings 430b, 432b in orientations that are substantially parallel to the axis A.

As to the first venting channel 220, air or gas fumes will enter the first venting channel 220 at the bottom end 208b as shown in FIG. 2B and exit at the top end 208a as shown in FIG. 2A. As shown in at least FIG. 2B, the first venting channel 220 includes an open bottom end 430b at the bottom end 208b of the assembly 120. As seen in at least FIGS. 3A-3C, an internal venting conduit 302 will be connected to the open bottom end 430b of the first venting channel 220, and air or gas fumes will enter a distal open end 304 of the internal venting conduit 302. The internal venting conduit 302 also includes an open opposite end 307 (or proximal end; see FIGS. 3A-3C) that is opposite the distal open end 304, and the internal venting conduit 302 further includes a lumen that extends through the internal venting conduit 302, between the distal open end 304 and the opposite open end 307. The open opposite end 307 of the internal venting conduit 302 is connected to the open bottom end 430b of the first venting channel 220, such that the lumen of the internal venting conduit 302 is in communication with the first venting channel 220, and air or gas fumes will then travel/flow through the lumen of the internal venting conduit 302 and into the first venting channel 220 of the assembly 120. In this manner, the air or gas fumes that may accumulate or form in the interior volume of the tank 102 may be vented out of the system 100 through the first venting channel 220 of the assembly 120.

However, as to the second venting channel 222, the second venting channel 222 is configured to receive a fluid limiting float valve (“FLVV”) and permit venting via a portion of the second venting channel 220. In the illustrated embodiment, the second venting channel 222 includes an upper portion 224a (see FIG. 2A) proximate to the top end 208a through which air or gas fumes may be vented, a lower portion 224b (see FIG. 2B) proximate to the bottom end 208b (and extending upward from the bottom end 208b) which is configured to receive the FLVV, and a window 226 disposed between the upper portion 224a and the lower portion 224b. In the illustrated embodiment, the window 226 is formed in the outer peripheral surface 250 of the receiver and is an opening through which the second venting channel 222 may be accessed from outside of the sleeve 202 and the assembly 120. The FLVV includes a float 230 that is slidably disposed/arranged in the second venting channel 222. The float 230 of the FLVV is operable to translate within the lower portion 224b, along an axis of the second venting channel 222 that is substantially parallel to the axis A. Thus, as detailed herein, the float 230 may rest in the second venting channel 222 and be positioned proximate to the bottom end 208b when resting/un-activated, but the float 230 may then translate/slide upward within the second venting channel 222 toward the top end 208a when activated. The float 230 is thus configured to move upward in the lower portion 224b in response to the fluid F exerting buoyancy forces on the float 230 and, in embodiments, the float 230 may be hollow or have an opening that faces the bottom end 208b that that may receive fluid F flowing into the lower portion 224b of the second venting channel 222 from the bottom end 208b.

For example, when exposed to and contacted by fluid (i.e., fuel), the float 230 will slide upward towards the upper portion 224a, until a tip 232 of the float 230 is seated within a bottom opening 234 (see FIG. 2B) of the upper portion 224a of the second venting channel 222. Seating of the tip 232 of the float 230 within the bottom opening 234 effectively closes the bottom opening 234 of the upper portion 224a such that the upper portion 224a is closed from the bottom and venting through the upper portion 224a is inhibited. Thus, the float 230 is slidable upward, towards the bottom opening 234, until the float 230 is in a closed position where the tip 232 is seated within the bottom opening 234 of the upper portion 224a, wherein access to the upper portion 224a is closed when the float 230 is in this fully upward and closed position which in turn closes the second venting channel 222 and inhibits venting through the second venting channel 222.

When unexposed to fluid (i.e., fuel) the float will 230 slide downward toward the bottom end 208 of the lower portion 224b, due to gravity, and rest in such downward (and un-activated position) such that the tip 232 of the float 230 is spaced away from (i.e., not seated within) the bottom opening 234 in the upper portion 224a of the second venting channel 222. Unseating of the tip 232 of the float 230 from the bottom opening 234 in this manner effectively opens the bottom opening 234 of the upper portion 224a such that the upper portion 224a is at least partially open from the bottom and venting through the upper portion 224a is at least partially permitted, as air or gas fumes may enter the upper portion 224a of the second venting channel 222 via the bottom opening 234 when the tip 232 of the float 230 displaced from the bottom opening 234. Thus, the float 230 is slidable downward, towards the bottom end 208b, until the float 230 is in an at least partially open position, wherein air or gas fumes may enter the upper portion 224a (through the window 226 and the bottom opening 234) and be vented out of the top end 208a of the assembly 120 via the upper portion 224a of the second venting channel 222.

The float 230 is retained in the lower portion 224b of the second venting channel 222. As shown, the float 230 is inhibited from exiting an upper end (proximate to the window 226) of the lower portion 224b, when sliding upward into the closed position, because the float 230 contacts a constricted portion 235 of the sleeve 202 surrounding the bottom opening 234. Also, the float 230 is inhibited from exiting the lower portion 224b at the bottom end 208b via a retaining means, and the float 230 may be retained within the lower portion 224b via a variety of retaining means. In the illustrated embodiment, the float 230 is retained via a float cap 240 that is coupled to the sleeve 202 via a rivet 242, as shown in FIG. 2B. However, in other embodiments, the float 230 may be retained by just the rivet 242 or some other means of inhibiting further downward sliding of the float 230. In this embodiment, the float 230 will contact the float cap 240 when the float 230 translates downward into its fully open (or lower most) position, such that the float cap 240 inhibits further downward translation of the float 230 and inhibits the float 240 from exiting the second venting channel 222. The float cap 240 also provides a visual indication to the installer as to which venting channel is the second venting channel 222, such that the installer will be informed as to where to connect certain components and conduits, as explained further below. This is because, as described above, the internal venting conduit 302 will be connected to the open bottom end 430b of the first venting channel 220, and the presence of the float cap 240 the second venting channel 222 will provide indication to the installer as to which of the channels is the first venting channel 220 for fluidly coupling it to a lumen of the internal venting conduit 302, and to help the installer avoid coupling the internal venting conduit 302 to the second venting channel 222. For example, the installer will see the float cap 240 in the second venting channel 222 and be able to immediately identify the first venting channel 220 as the channel without the float cap 240, and then connect the internal venting conduit 302 to the first venting channel 220 that does not include the float cap 240.

Referring now to FIGS. 3A-3C, the tank 102 of the system 100 is depicted as being transparent such that a level L of fluid F within the tank 102 is visible. FIGS. 3A-3C also depict the tank 102 at different orientations/attitudes relative to horizontal axis H and a vertical axis V. Due to regulations and standards requiring a minimum amount of ullage, an air gap G will be present above the fluid level F during use, and the air gap G is also visible in these illustrations. As previously mentioned, during use, the tank 102 of the system 100 may be oriented in various attitudes depending on the attitude of the watercraft and/or the location on the watercraft at which the tank 102 is mounted. However, the fluid level L of the fluid F within the tank 102 will stay substantially horizontal (and thus substantially parallel to the horizontal axis H) regardless of the attitude/orientation of the tank 102, such that different portions of the system 100 may be below the fluid level L (and in contact or inundated with the fluid F such that they are not exposed to the air gap G) or above the fluid level L (and exposed to the air gap G) depending on the attitude/orientation of the tank 102. In FIG. 3A, the system 100 is depicted when the tank 102 is at a substantially horizontal orientation, where a length dimension D of the tank 102 is oriented substantially parallel to the horizontal axis H, and where the stern end 136b and the bow end 136a are at relatively equal elevations relative to the horizontal axis H, which is referred to as a “level” orientation. Also, when the assembly 120 is installed in the neck 104 of the tank 102, a gap or space is present between the outer peripheral surface 250 of the sleeve 202 of the assembly 120 and an internal surface 300 of the neck 104 of the tank 102, such that the window 226 is exposed to and in fluid communication with the interior volume of the tank 102. In the illustrated embodiment, the fluid level L is beneath the neck 104 and the bottom end 208b of the assembly 120 when the tank is in the level orientation depicted in FIG. 3A, such that the float 230 contained (and constrained) in the second venting channel 222 is not in contact with the fluid F and such that the window 226 is exposed to the air gap G. Stated differently, the assembly 120 and the neck 104 are above the fluid level L such that they are not in contact with the fluid F when the tank 102 is in this level orientation. Because the float 230 is not in contact with the fluid F in this level orientation, the float 230 will be in the open position where the float 230 is located at or proximate to the bottom of the second portion 224b of the second venting channel 220 (possibly resting on the retaining means therein), and the bottom opening 234 of the upper portion 224a of the second venting channel 222 will be unobstructed by the float 230 such that venting through the upper portion 224a will be possible. Gas fumes or air accumulating in the tank 102 may then travel up through the neck 104 of the tank 102, between the outer peripheral surface 250 of the sleeve 202 and the internal surface 300 of the neck 102, then flow through the window 226 and into and through the upper portion 224a of the second venting channel 222 via the bottom opening 234, and then flow out of the upper portion 224a of the second venting channel 222 at the top end 208a.

Also, while the entirety of the assembly 120 is illustrated as being not in contact with the fluid F in the level orientation shown in FIG. 3A, in some applications the fluid level L may be higher than the bottom end 208b of the assembly 120 and still permit venting via the second venting channel 222. For example, in such application, fluid level L may be sufficiently high enough to at least partially translate the float 230 upward in the lower portion 224b of the second venting channel 222, but not enough to occlude (or fully block) the bottom opening 234 of the upper portion 224a of the second venting channel 222, such that venting of air or gas fumes may still occur through the window 226 and the upper portion 224b of the second venting channel 222.

In the example level orientation of the system 100 illustrated in FIG. 3A, the distal open end 304 of the internal venting conduit 302 is also above the fluid level L, such that the distal open end 304 is also exposed to the air gap G. Stated differently, the distal open end 304 of the internal venting conduit 302 is within and opens into the air gap G so that air or gas fumes of the air gap G may travel into the internal venting conduit 302 via the distal open end 304. Thus, in the illustrated embodiment, venting of air or gas fumes from the tank 102 may also be accomplished via the first venting channel 220, as air or gas fumes may travel into and through the internal venting conduit 302 (via the distal open end 304) and through the first venting channel 220, as described herein. Thus, in the illustrated embodiment, when the system 100 is in the level orientation shown in FIG. 3A, venting may occur through both the first venting channel 220 and the second venting channel 222. However, in other embodiments, the fluid level L may be above the distal open end 304 and/or the internal venting conduit 302 may be positioned lower within the tank 102 such that venting would not occur through the first venting channel 220 when the system 100 is in the level orientation.

In FIG. 3B, the tank 102 is oriented at an attitude where the stern end 136b is elevated relative to the bow end 136a (i.e., the stern end 136b is higher than the bow end 136a in view of the horizontal axis H), which is referred to as a “stern up” orientation. In the illustrated stern up orientation the fluid level L is still beneath the neck 104 and the assembly 120. Because the fluid level L is below the neck 104 and the assembly 120, the air gap G fills (or exists in) the portion of the interior volume of the tank 102 within which the neck 104 and the assembly 120 are located, such that the neck 104 and the assembly 120 are exposed to the air gap G and, in particular, the bottom end of the second venting channel 222 and the window 226 will also be exposed to the air gap G. Further, because the bottom end of the second venting channel 222 is exposed to the air gap G rather than the fluid F, the float 230 will be in the open position where it is resting at the bottom end the lower portion 224b of the second venting channel 222, proximate to the bottom end 208b, as it is not acted upon by the buoyant force of the fluid F. Thus, venting of air or gas fumes from the tank 102 when in the stern up orientation may still be accomplished via the second venting channel 222, as described above.

In FIG. 3C, the system 100 and the tank 102 thereof are oriented at an attitude where the bow end 136a is elevated relative to the stern end 136b (i.e., the bow end 136a is higher than the stern end 136b with reference to the horizontal axis H), which is referred to as a “bow up” orientation. In the illustrated bow up orientation, the neck 104 and the assembly 120 are under the fluid level L and thus emerged in the fluid F (i.e., the neck 104 and the assembly 120 are under the fluid F and exposed to the fluid F). As described above, the assembly 120 is configured to close at least a portion of the second venting channel 222 when in this submerged condition to inhibit fuel from escaping out of the assembly 120 (and, thus, the system 100) via the second venting channel 222. In particular, in this bow up orientation, which causes the neck 104 to be at least partially filled with the fluid F and which in turn causes at least the bottom end 208b of the assembly 120 to be submerged in the fluid F, the fluid F causes the float 230 to translate within the lower portion 224b of the second venting channel 222 into the closed position, wherein the tip 232 of the float 230 engages the constricted portion 235 and thereby blocks or closes the bottom opening 234 of the upper portion 224a of the second venting channel 222, such that venting through the upper portion 224a is inhibited and such that the fluid F is prohibited from flowing/leaking through the upper portion 224a of the second venting channel 222.

However, when the system 100 and the tank 102 are in this bow up orientation, venting is possible via the first venting channel 220, because the distal open end 304 of the internal venting conduit 302 is exposed to the air gap G. In the illustrated embodiment, the internal venting conduit 302 that is in communication with the first venting channel 220 extends from the bottom end 208b of the assembly 120, within and through the inner volume of the tank 102 towards the bow end 136a in a manner that positions the distal open end 304 at and proximate to the bow end 136a of the tank 102. When the tank 102 is oriented in the bow up attitude, as exemplified in FIG. 3C, the internal venting conduit 302 will extend upward through the fluid F such that the distal open end 304 thereof is positioned above the fluid level L and within the air gap G. Thus, venting of air or gas fumes may be achieved through the internal venting conduit 302 and the first venting channel 220. However, when the tank 102 is oriented as shown in FIG. 3A or 3B, the venting conduit 302 and the first venting channel 220 may or may not provide venting depending on whether the distal open end 306 is submerged within the fluid F beneath the fluid level L. For example, if the fill level L of the fluid F is as shown in FIG. 3B, the distal open end 304 is submerged and venting through the first venting channel 220 and the venting conduit 302 is inhibited. Accordingly, the assembly 120 is configured to permit venting therethrough regardless of whether the tank 102 is in the bow up orientation, the stern up orientation, or level orientation, and the assembly 120 is also configured to inhibit leaking of the fluid L regardless of orientation of the tank 102.

Referring again to FIG. 2B, the sleeve 202 includes a lower conduit 262 extending downward from a body portion 264 of the sleeve 202. The lower conduit 262 is hollow and defines a passageway 280 through which a portion of the fluid F input into the assembly 120 at the top end 208a may flow. The lower conduit 262 includes an upper end 266a and a lower end 266b, with the inner passageway 280 of the lower conduit 262 extending through the lower conduit 262 between the upper end 266a and the lower end 266b, from an upper opening 267 (FIGS. 4C and 4D) at the upper end 266a to a lower opening at the lower end 266b. The lower conduit 262 is suspended and supported within the central bore 206 via an arm 268 that radially extends into the central bore 206. As shown, the arm 268 positions the upper opening 267 at the upper end 266a of the lower conduit 262 radially inward towards an inner region or near the center of the opening 260. The check valve 210 may be shaped to receive the arm 268 and the lower conduit 262 when the check valve 210 is in the closed position, such that the opening 260 is closed via the check valve 210 and inhibiting the presence of any openings or gaps through which fluid may flow when the check valve 210 is closed. In the illustrated example, the check valve 210 includes a cut away 270 that is formed and shaped to receive the arm 268 and the lower conduit 262 when closed, wherein the cut away 270 defines a pair of arms that wrap around opposite sides of the lower conduit 262 and the arm 268, such that the check valve 210 effectively closes the opening 260 when in the closed position.

Referring now to FIGS. 4A-4D, a top view of the assembly 120 is illustrated in FIG. 4A and a side view of the assembly 120 is shown in FIG. 4B. FIG. 4C is a cross-sectional view of the assembly along section line FIG. 4C-FIG. 4C in FIGS. 4A-4B, and FIG. 4D is a cross-sectional view of the assembly along section line FIG. 4D-FIG. 4D in FIG. 4A.

As best shown in FIG. 4A, the sleeve 202 may include a top surface 490 and the upper openings 430a, 432a are formed in the top surface 490. In embodiments, the top surface 490 is an annular shaped surface that surrounds the central bore 206 and the receiver 204 when the receiver 204 is installed therein. In embodiments, the top surface 490 includes a raised portion 492 and a recessed portion 494 and, in such embodiments, the upper openings 430a, 432a are formed in the recessed portion 494 that is offset downward from the raised portion 492 toward the bottom end 208b. The presence of the recessed portion 494 of the top surface 490 may help ensure that the upper openings 430a, 432a are not obstructed, for example, by the adapter 110, and to thereby ensure that venting out through the upper openings 430a, 432a is possible when the system 100 is assembled with the adapter 110 and the cap 112 tightened down onto the neck 104. In the illustrated embodiment, the raised portion 492 is annular shaped and the recessed portion 494 is located radially inward from the outer annular raised portion 492. Thus, in the illustrated embodiment, the first venting channel 220 extends between the upper opening 430a thereof and the bottom opening 430b thereof, with the upper opening 430a being formed in the recessed portion 494 of the top surface 490 and with the bottom opening 430b being formed in the bottom surface 290. Similarly, the second venting channel 222 extends between the upper opening 432a thereof and the bottom opening 432b thereof, with the upper opening 432a being formed in the recessed portion 494 of the top surface 490 and with the bottom opening 432b being formed in the bottom surface 290; however, as mentioned above, the assembly 120 further includes the window 226 formed in the outer peripheral surface 250 of the sleeve 202 through which at least a portion of the second venting channel 222 may be accessed.

As shown in at least FIG. 4C, the receiver 204 may be secured within the sleeve 202 via a rivet 480. As shown, the sleeve 202 and the receiver may each include an opening that are aligned with each other when the receiver 204 is positioned inside the sleeve 202, and then the rivet 480 may be inserted through the openings of the sleeve 202 and the receiver 204, from an outside of the assembly 120, as depicted.

As shown at least in FIGS. 4C and 4D, the assembly 120 includes a venturi sub-assembly or extension 400, in addition to the sleeve 202 and the receiver 204. Thus, in the illustrated embodiment, the assembly 120 includes the sleeve 202, the receiver 204, and the venturi extension 400. Also, the central bore 206 of the assembly 120 includes an upper chamber 412 and a lower chamber 414, with the upper chamber 412 being defined within the receiver 204 when assembled and the lower chamber being defined within the sleeve 202 when assembled. As shown, the arm 268 extends radially inward into the lower chamber 414 of the central bore 206 to thereby position the upper opening 267 at the upper end 266a of the lower conduit 262 radially inward towards the inner region of the lower chamber 414 of the central bore 206.

The venturi extension 400 includes a body 402 and an arm 404 extending from the body 402. The body 402 is a conduit that defines a passageway 406, extending between an upper end 408a and a lower end 408b of the body 402. The body 402 includes an upper opening 410a at the upper end 408a and a lower opening 410b at the lower end 408b. As shown, the body 402 is attached to the upper end 266a of the lower conduit 262, such that the passage 280 that extends through the lower conduit 262 is in fluid communication with and sealed with the passageway 406 that extends through the body 402 of the venturi extension 400. Thus, the lower opening 410b is arranged to communicate with the upper opening 267 defined in the upper end 266a of the lower conduit 262. In the illustrated embodiment, the lower end 408b of the body 402 is seated within the upper opening 267 at the upper end 266a of the lower conduit 262, such that the venturi extension 400 is at least partially supported by the sleeve 202.

The venturi extension 400 is also at least partially supported by the receiver 204. In the illustrated embodiment, the venturi extension 400 is configured to snap or lock onto a feature or portion of the receiver 204 after being seated in the sleeve 202. Here, for example, the arm 404 of the venturi extension 400 includes a snap 420 that is attachable to a corresponding feature 422 of the receiver 204. As shown, the corresponding feature 422 of the receiver 204 is configured to receive the snap 420, such that the snap 420 and the feature 422 together define a “snap fit connection” that may be snapped together when desired to attach the venturi extension 400 or unsnapped when it is desired to remove the venturi extension 400. Thus, the venturi extension 400 is removably coupled to both the sleeve 202 and the receiver 204.

The venturi extension 400 is positioned such that the upper opening 410a thereof is positioned beneath the upper chamber 412. The upper chamber 412 is configured to receive the fuel dispensing nozzle and, in this manner, when the fuel dispensing nozzle is inserted into the upper chamber 412 and fluid is dispensed into the upper chamber 412, some of that fluid will enter the upper opening 410a of the venturi extension 400, and the rest of that fluid will flow past the venturi extension 400 and enter the lower chamber 414. The fuel entering the lower chamber 414 will be under pressure and will open the valve 210 such that it may enter the interior volume of the tank 102.

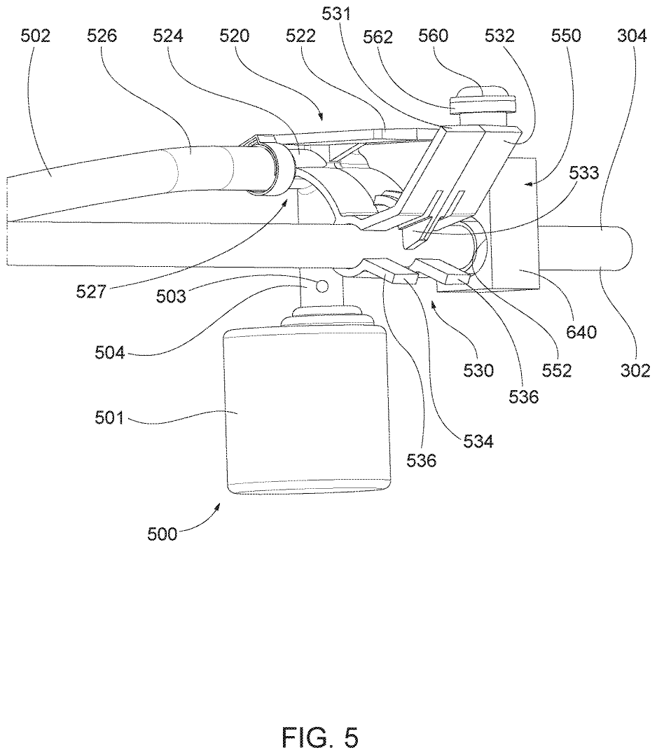

The venturi extension 400 is operably coupled to a shutoff valve 500, an example of which is depicted in FIG. 5. As shown in FIGS. 3A-3C and FIG. 5, the system 100 includes a conduit 502 that is connected to the lower end 266b of the lower conduit 262, such that a passageway (or lumen) defined within the conduit 502 is in communication with the passageway 280 of the lower conduit 262 and the passageway 406 of the venturi extension 400. As shown in FIG. 3A-3C, the conduit 502 extends through the interior volume of the tank 102 and is in communication with the shutoff valve 500, and with the shutoff valve 500 being located proximate to the distal end 304 of the internal venting conduit 302 in the illustrated example. Thus, a distal end 526 of the conduit 502 is connected to the shutoff valve 500 (i.e., to the clip 520 thereof) and a proximal end 505 of the conduit 502 is connected to the lower conduit 262 of the assembly 120. While the shutoff valve 500 is depicted in FIGS. 3A3C as being closer to the bow end 136a than to the stern end 136b, the shutoff valve 500 may be differently located within the internal volume of the tank 102, for example, the shutoff valve 500 may be arranged at a mid-point between the ends 136a, b and at a mid-point between sides 138a, b, such that the shutoff valve 500 is centrally oriented within the interior volume of the tank 102; and, in such embodiments, the distal end 304 of the internal venting conduit 302 may extend beyond the shutoff valve 500, toward the bow end 136a to facilitate placement of the shutoff valve 500 near a midpoint of the tank 102 while also facilitating placement of the distal end 304 proximate to the bow end 136a. In embodiments, the shutoff valve 500 is located at a mid-point or central region of the internal venting conduit 302, somewhere in between the distal end 304 and the proximal end 307.

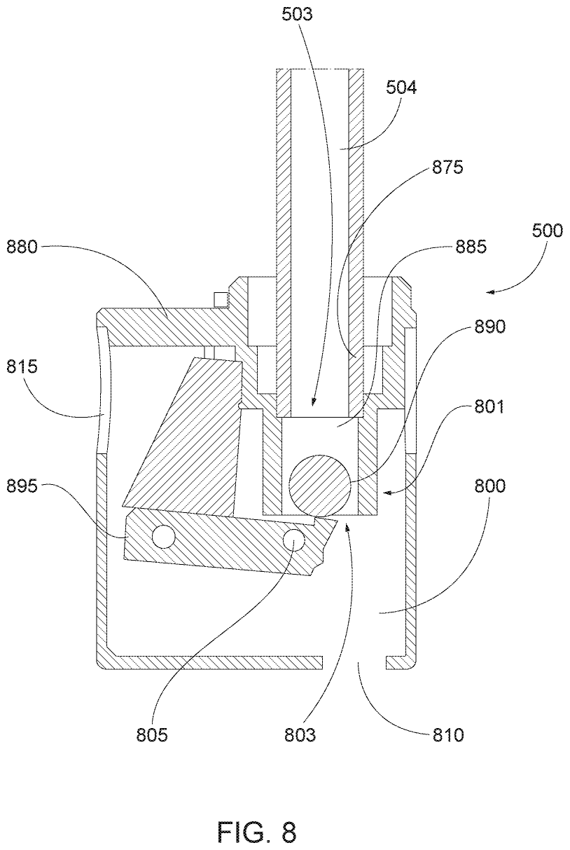

The system 100 also includes a conduit 504 that is in communication with both the conduit 502 and the shutoff valve 500, and the shutoff valve 500 is attached to and suspended from the conduit 504. The conduit 504 is hollow and includes an internal passageway (or lumen) that is in communication with the passageway of the conduit 502 and is in communication with the interior working components of the shutoff valve 500, such that the conduit 504 fluidly interconnects the conduit 502 and the shutoff valve 500. During use, when fluid (e.g., fuel) is input/injected into the assembly 120, by inserting the fuel dispensing nozzle (not shown) into the upper chamber 412 and then activating the fuel dispensing nozzle to thereby output the fluid into the upper chamber 412, the fluid will enter the upper opening 410a at the upper end 408a of the passageway 406 (of the venturi extension 400), and then the fluid will travel through the passageways 406 and 280 and into the passageways of the conduits 502 and 504. From there, the fluid F may then exit the conduit 504 via a hole or opening 503 formed in the downward extending conduit 504. However, as mentioned below, the shutoff valve 500 is operable to close the opening 503 depending on how high the fluid level L is within the tank 102, wherein fluid would be inhibited from exiting the conduit 504 when the opening 503 is closed by the shutoff valve 500. While the opening 503 is shown on a circumferential surface of the conduit 504, the opening 503 may be differently located. For example, the shutoff valve 500 and the opening 503 in the conduit 504 may be differently configured as depicted in FIG. 8.

In the illustrated embodiment, the shutoff valve 500 is a float 501 that will slide upward and downward along the downward extending conduit 504 and float 501 and raise with the fluid level L, as the fluid F within the interior volume of the tank 102 may apply a buoyant force on the float 501 of the shutoff valve that will urge/force the float 501 upward with rising fluid level L and float 501 may also translate/slide downward as the fluid level L decreases/lowers within the tank 102. In embodiments, the float is made of a foam that will slide upward when surrounded by the fluid F, such that the float will close the opening in the downward extending conduit 504. The length of the downward extending conduit 504 may be selected based on how much ullage is needed (i.e., based on how much maximum fluid level L is desired/permitted and/or the minimum desired volume of the air gap G).

As mentioned, the float 501 may slide upward or downward along the conduit 504 to thereby open or close the opening 503 in the conduit 504. As the fluid level L rises within the tank 102, the fluid F causes the float 501 to translate/slide upward along the conduit 504. When no fluid F is in the tank 102 and/or when an insufficient amount of fluid F is present in the tank 102 to cause the float 501 to slide upward along the conduit 504, the float 501 will be in a resting position wherein the opening 503 is exposed/open (i.e., not closed by the float 501) as shown in FIG. 5. However, when the fluid level L in the tank 102 rises and reaches a predetermined level where the fluid F contacts the float 501 and applies an upwardly directed buoyant force on the float 501 to thereby cause the float 501 to slide upward along the conduit 504 (toward the conduit 502), the float 501 may close, cover, or block the opening 503 in the downward extending conduit 504. Closure of the opening 503 in the conduit 504 inhibits the fluid F contained in the conduits 502 and 504, as well as the lower conduit 262 and the passageway 406 to exit via the opening 503, which in turn causes fluid F to back up in the conduits 502 and 504, the lower conduit 262, and the passageway 406, and the backing up of the fluid F in the passageway 406 causes increasing fuel level in the passageway 406 towards the upper end 408a. The rising fluid level in the passageway 406 will eventually reach the level of the arm 404, as which time the fluid F is diverted into the upper passage 460 in the arm 404 and into a corresponding upper passage 462 in the receiver 204, and into the upper chamber 412 within which the fuel dispensing nozzle is inserted. This back flow of fluid flowing into the upper chamber 412 via the venturi extension 400 will enter a pressure sensing hole in the dispensing nozzle, thereby triggering the auto shut off feature of the dispensing nozzle, shutting off the flow of fluid from the fuel dispensing nozzle.

Referring to FIG. 8, an alternate embodiment of the shutoff valve 500 is depicted. In the illustrated example, the shutoff valve 500 is attached to and suspended from the conduit 504 via an instant fitting 875, or other suitable fitting, inserted in a bore through the valve body 880 of the shutoff valve 500. A counter bore 885 in the valve body 880 has a lower end 801 which has a through hole 803, and the through hole 803 has a diameter that is smaller than a diameter of a check ball 890. When the check ball 890 rests on the lower end 801 of the counter bore 885, the check ball 890 blocks the hole 803 and thereby blocks the flow of fluid through the valve body 880. A float 895 is disposed within a chamber 800 of the valve body 880, and the float 895 includes a lever that is in contact with the check ball 890. The float 895 further includes a pivot 805 below the check ball 890. Gravity lowers the float 895 on the pivot 805, thereby causing the lever to lift the check ball 890 off a seat at the lower end 801 which in turn moves the shutoff valve 500 into an open position where fluid flowing out of the opening 503 in the conduit 504 may exit the shutoff valve 500 and enter the interior volume of the tank 102. The chamber 800 has at least one hole 810 in the bottom portion and at least one hole 815 in the top portion. When the fuel level in the tank 102 reaches a predetermined maximum fill level, the float 895 rises on the pivot 405, thereby causing the lever to lower the check ball 390 onto its seat at the lower end 801 which in turn closes the shutoff valve 500 due to the larger diameter of the check ball 890 obstructing the hole 803. A spring may be used to bias the float 895 in the open position. As may be understood by one with skill in the art, any other method may be used to at least partially block the flow through the conduit 504.

In the illustrated embodiments, the conduit 502 and the shutoff valve 500 are supported by the internal venting conduit 302. As shown, the conduit 502 and the shutoff valve 500 are connected or coupled to the internal venting conduit 302 via a clip 520 of the shutoff valve 500. Here, the clip 520 includes an upper base 522 that will be rested flush against an inner surface of a top wall 141 (FIG. 1) within the tank 102, as also depicted in FIGS. 6A-6B. Also in this embodiment, the downward extending conduit 504 is integral with the clip 520, such that the conduit 504 is part of the clip 520, and the clip 520 includes an input segment 524 that connects to the distal end 526 of the conduit 502 and the input segment 524 transitions into the downward extending conduit 504 at an elbow 527, such that the input segment 524 receives the fluid F from the conduit 502 and the elbow 527 re-directs such fluid F downward into and through the conduit 504, toward the shutoff valve 500, and into the interior volume of the tank 102 when the shutoff valve 500 is an open condition, for example, where the float 501 does not obstruct the opening 503 in the conduit 504 or where the check ball 890 does not obstruct the hole 803. Thus, the clip 520 includes an interior passageway (obscured from view) that extends through the input segment 524, the elbow 527, and the conduit 504, wherein such interior passageway of the clip 520 communicates with the passageway of the conduit 502 when assembled together.

The clip 520 is configured to attach to the internal venting conduit 302. In the illustrated embodiment, the clip 520 includes a locking arm 530. The lock arm 530 extends from a body of the clip 520, such as from at least a portion of the input segment 524 and/or from at least a portion of the elbow 527, and the locking arm 530 is configured to attach to another component such that the other component can provide support to the clip 520, the conduit 502 connected to the clip 520, and the shutoff valve 500 that is suspended from the clip 520. In the illustrated embodiment, the lock arm 530 includes an upper portion 532 and a lower portion 534 that are configured to permanently retain the internal venting conduit 302. As shown, the upper and lower portions 532, 534 together define a channel through which the internal venting conduit 302 may extend when assembled and, therefore, such channel may have a cylindrical shape that corresponds to the shape of the internal venting conduit 302. Also, the upper portion 532 extends in a generally upward direction toward the upper base 522, and the upper portion 532 terminates at an edge 531 that is at a substantially equal elevation of as the upper base 522 such that, when the clip 520 is installed on/in the tank 102, as hereinafter described, both the upper base 522 and the upper edge 531 of the upper portion 532 will contact/abut the interior surface of the top wall 141 of the tank 102. Here, the upper portion 532 includes a tooth 533 that bears against the internal venting conduit 302 when the internal venting conduit 302 is assembled and retained within the lock arm 530 (i.e., when retained between the upper and lower portions 532, 534), and the lower portion 534 includes a pair of prongs 536 spaced apart from each other to receive the tooth 533; but the upper portion 532 and/or the lower portion 534 may be differently configured. The upper portion 532 and the lower portion 534 together define the channel within which the internal venting channel 302 may be received, and the upper portion 532 and the lower portion 534 may flex of be biased such that they be flexed/spread apart from each other to allow the internal venting conduit 302 to be inserted therein, and then the bias of the upper portion 532 and the lower portion 534 causes the upper portion 532 and the lower portion 534 to move towards each other and thereby enclose the internal venting conduit 302 within the channel defined therein, with the tooth 533 helping to maintain the internal venting conduit 302 within the channel and inhibiting the internal venting conduit 302 from exiting said channel. Also, when the clip 520 is installed in the tank 102 such that the upper base 522 and the edge 531 (of the upper portion 532) of the clip 520 both abut, contact, and bear against the inner surface of the top wall 141 of the tank 102, removal of the internal venting conduit 302 from between the upper and lower portions 532, 534 of the locking arm 530 of the clip 520 is inhibited. This is because the internal venting conduit 302 will engage the tooth 533 when it is attempted to be withdrawn from the locking arm 530, and such attempted withdrawal of the internal venting conduit 302 will urge/push the upper portion 532 upward toward the inner surface of the top wall 141, but the edge 531 of the upper portion 532 is already in contact and abutting the inner surface of the top wall 141 of the tank 102, such that further upward movement of the upper portion 532 will be inhibited by the top wall 141, and thereby provide permanent attachment of the internal venting conduit 302 in the clip 520.

FIG. 6A depicts a cross-section of the system 100 taken along the internal venting conduit 302, according to embodiments. FIG. 6B is an up close detailed view of a portion of the system 100 shown in FIG. 6A. While FIG. 5 depicts the shutoff valve 500 and the clip 520 thereof when not assembled in the tank 102, FIGS. 6A and 6B together illustrate how the clip 520 supports the shutoff valve 500 within the interior volume of the tank 102 and how the upper base 522 of the clip 520 is pressed and held in contact with and against an inner surface 606 of the top wall 141 of the tank 102 when assembled in the tank 102.

As shown in FIG. 5 and FIGS. 6A-6B, the system 100 also includes a tube holder 550 that is utilized to couple the internal venting conduit 302 to the tank 102, and these figures also depict how the tube holder 550 and the internal venting conduit 302 couple the float valve 500 and the clip 520 to the tank 102. As shown in FIG. 5, the tube holder 550 comprises an insert 640 and a material (such as the material 602 used to mold the tank 102) applied on or over (e.g., via molding) the insert 640, thereby encapsulating the insert 640. Thus, the tube holder 550 may be a molded component and may the material 602 covering the insert 640 may be applied to (i.e., molded on) the insert 640 in the same step as formation of the tank 102, such that the material 602 is used to form the tank 102 and also applied to the insert 640 in a single step of molding (i.e., a single molding step). In an embodiment, the insert 640 is formed/constructed from a metallic material (e.g., aluminum or steel) and the material molded thereon (i.e., the material 602) is a plastic (e.g., polyethylene).

The tube holder 550 includes a bore 552 that extends through both the insert 640 and the material 602 applied thereon, and the distal end 304 of the internal venting conduit 302 will extend through the bore 552 when assembled. In embodiments, the distal end 304 of the internal venting conduit 302 includes a low friction sleeve 642 arranged around an outer circumferential surface of the internal venting conduit 302, wherein the low friction sleeve 642 is operable to permit relative sliding of the internal venting conduit 302 within the bore 552 of the tube holder 550. In embodiments, the low friction sleeve 642 is a Teflon sleeve. In embodiments, the internal venting conduit 302 is inserted through the bore 552 in the insert 640 prior to molding the tank 102 using the material 602, such that the molding step utilized to both form the tank 102 and apply the material 602 on the insert 640 will cause some of the material 602 to contact the internal venting conduit 302 and thereby help retain and secure the internal venting conduit 302 within the insert 640. Sometimes during manufacture of the tank 102, relative sliding between the internal venting conduit 302 and the tube holder 550 may occur and inclusion of the low friction sleeve 642 may inhibit the internal venting conduit 302 from sticking to the tube holder 550 and permit relative movement there-between so as to inhibit damage that may otherwise occur. For example, after molding the tank 102 using the material 602, the tank 102 may undergo cooling which in turn may result in shrinkage of the tank 102. Here, inclusion of the low friction sleeve 642 on the segment of the internal venting conduit 302 arranged within the bore 552 will inhibit the internal venting conduit 302 from sticking/attaching to the tube holder 550 and thereby allow relative movement/sliding of the internal venting conduit 302 within the bore 552 of the tube holder 550 that may occur as the tank 102 shrinks after manufacture.

As best shown in FIG. 6B, the insert 640 of the tube holder 550 may be attached to the tank 102 via the molding process/step. In particular, the insert 640 may be molded into the tank 102 during the molding step where the material 602 is used to form the tank 102, such that the insert 640 is at least partially encapsulated within the material 602 utilized to mold the tank 102. In this manner, the insert 640 is integrally formed with the tank 102 and secured via the material 602 of the tank 102. As hereinafter described, the tank 102 may be formed via a molding step and, in that molding step, molds (not shown) of the tank 102 may be provided and the insert 640 may be connected within the mold via a fastener that extends into and through the mold, into an interior of the mold and into a bore 644 formed in the insert 640; and then, with the insert 640 secured within the mold via the fastener, the tank 102 may be molded using the material 602 and, not only will the material 602 form the walls of the tank 102, but the material 602 will flow at least partially over and around the insert 640, such that the insert 640 is integral with the tank 102 and at least partially encapsulated via the material 602 of the tank 102. Then, after completion of the molding step, the fastener utilized to secure the insert 640 within the mold (during the molding process) may be removed, which thereby exposes the bore 644 that extends through the exterior surface 140 of the top wall 141 of the tank 102 and into the insert 640, such that the bore 644 is a blind hole 645 that extends into the exterior surface 140 of tank 102 and into the insert 640. Thereafter, a fastener 560 (e.g., a bolt or screw) may be inserted into the blind hole 645 to further secure the tube holder 550 to the tank 102 and, more specifically, to strengthen the attachment of the insert 640 to the tank 102. However, as best shown in FIG. 6B, the insert 640 includes a body portion 677 and a neck portion 679 extending upward from the body portion 677 and having a relatively smaller width/diameter in cross section, such that the insert 640 is trapped within the material 602 due to the size difference as the material 602 surrounding the neck portion 679 inhibits removal/withdrawal of the insert 640 from the tank 102, outward from the exterior surface 140. Thus, while molding the material 602 around the insert 640 when molding the tank 102 fastens/secures the insert 640 to the top wall 141 of the tank 102, the fastener 560 may be utilized (not only to fill the blind hole 645 that results from the molding step, but) to further strengthen the attachment of the insert 640 to the tank 102. In embodiments, a gasket 562 may be arranged on/around the fastener 560 to help seal the blind hole 645 at the exterior surface 140. In embodiments, the gasket 562 is an oil resistant neoprene rubber sealing washer that ensures no fluid/fuel would leak out of the blind hole 645 in the event a leak were to develop there.

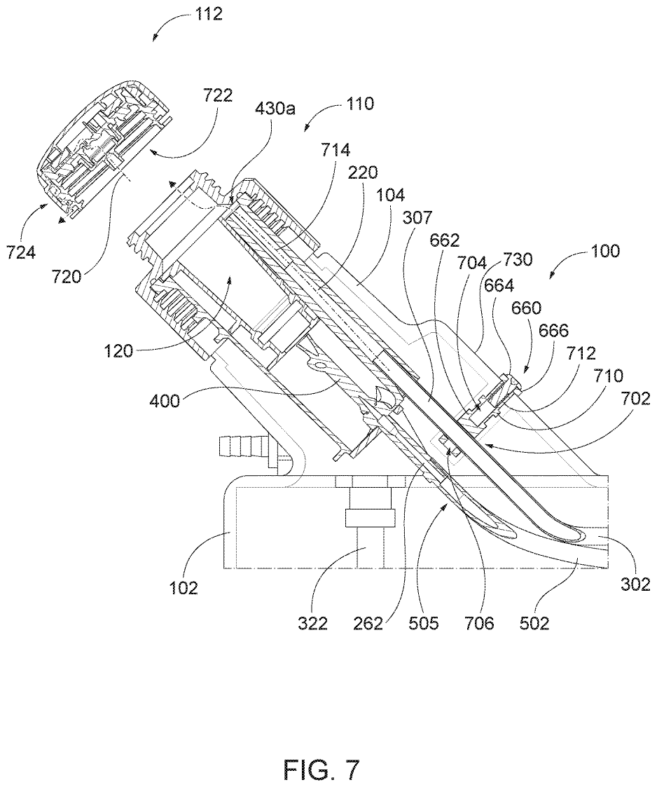

In addition to the tube holder 550, the system 100 may include an upstream tube holder 660 utilized to support the internal venting conduit 302 at a location within the tank 102 that is upstream (or closer to the assembly 120) than the tube holder 550. FIG. 7 depicts a cross section of the system 100 that depicts the assembly 120 within the neck 104 of the tank 102, according to an embodiment. In the illustrated embodiment, the upstream tube holder 660 is mounted within the neck 104 of the tank 102 and includes a bore 702 through which the internal venting conduit 302 may extend to thereby provide support to the internal venting conduit 302 (and, in particular, the proximal end 307 of the internal venting conduit 302) as it extends and runs up through the neck 104 of the tank 102 and into the assembly 120. Thus, with inclusion of the upstream tube holder 660, the internal venting conduit 302 will be supported inside of the tank 102 at three separate and spaced apart locations, including the assembly 120, the tube holder 550 and the upstream tube holder 660, and the upstream tube holder 660 provides additional support for the internal venting conduit 302 as it extends into and through the neck 104 and to the assembly 120. Also, in the illustrated embodiment, the neck 104 of the tank 102 includes a expanded or enlarged portion 730 protruding from the neck 104 and meeting the tank 102 body, and the upstream tube holder 660 is mounted to the neck 104 from within or inside of the expanded or enlarged portion 730 of the neck 104 to help align the proximal end 307 of the internal venting conduit 302 with the first venting channel 220. Thus, as shown, the expanded or enlarged portion 730 of the neck 104 provides additional space or clearance for receiving and mounting the upstream tube holder 660 inside of the tank 102 so that the internal venting conduit 302 is positioned in alignment with the first venting channel 220 of the assembly 120.

As shown, the upstream tube holder 660 includes an upstream insert 662 (hereinafter, the “insert 662”) and the material 602 utilized to mold the tank 102, which is molded onto or over the insert 662, thereby encapsulating the insert 662. Thus, the upstream tube holder 660 may be a molded component and may be molded in the same step as the tank 102 and the tube holder 550, such that the material 602 is applied to and molded onto both the insert 640 and the insert 662 in a single step, and wherein the tank 102 is formed from the material 602 in that same step. In an embodiment, the insert 662 is formed/constructed from a metallic material (e.g., aluminum or steel). The low friction sleeve 642 may also be applied to the portion of the internal venting conduit 302 that is located in the bore 702 of the insert 662. The insert 662 further includes an upper bore 704 and a lower bore 706 that are non-parallel with the bore 702 through which the internal venting conduit 302 is arranged. The upper bore 704 is a blind hole, meaning it does not communicate with the bore 702; however, the lower bore 706 extends into and is in communication with the bore 702. Thus, during assembly of the system 100, a fastener (e.g., a set screw) may be installed in the lower bore 706 to help retain/secure the internal venting conduit 302 within the bore 702. In embodiments, the lower bore 706 may be covered with the material 602 as a result of the molding process utilized to form the tank 102 with the internal venting conduit 302 supported therein and extending up through the neck 104 and, where such a set screw is utilized to help retain the internal venting conduit 302 within the insert 6602, such set screw may be screwed/inserted through the portion of the material 602 that covers the lower bore 706 before being inserted into the lower bore 706. In embodiments, the internal venting conduit 302 may also or instead be welded within the bore 702 of the upstream tube holder 660.

To form the upstream tube holder 660 and integrate it with the tank 102, the insert 662 may be connected within the mold via a fastener that extends into and through the mold, into an interior of the mold and into the upper bore 704 formed in the insert 662; and then, with the insert 662 secured within the mold via the fastener, the tank 102 may be molded using the material 602 and, not only will the material 602 form the walls of the tank 102 (and at least partially encapsulate the downstream insert 640 detailed above), but the material 602 will flow at least partially over and around the insert 662, such that the insert 662 is integral with the tank 102 and at least partially encapsulated via the material 602 of the tank 102. Then, after completion of the molding step, the fastener utilized to secure the insert 662 within the mold (during the molding process) may be removed, which thereby exposes the upper bore 704 of the insert 662, such that the upper bore 704 is a blind hole that extends into the exterior surface 140 of tank 102 and into the insert 640. This results in the insert 662 being trapped within the material 602 of the tank 102, in a similar manner as described above with reference to the insert 640 of the tank holder 550. For example, the insert 662 may include a geometry that restricts its withdrawal from the tank 102 after it has been molded thereto. In the illustrated embodiment, the insert 662 includes a flange 710 and a neck portion 712 extending upward from the flange 710 and the body of the insert 662, wherein the neck portion 712 has a relatively smaller width/diameter in cross section than the flange 710, such that the insert 662 is trapped within the material 602 due to the size difference as the material 602 surrounding the neck portion 712 inhibits removal/withdrawal of the insert 662 from the tank 102, outward from the exterior surface 140. Thereafter, a fastener 664 (e.g., a bolt or screw) may be inserted into the blind hole and the upper bore 704 to further secure the upstream tube holder 660 to the tank 102 and, more specifically, to strengthen the attachment of the insert 662 to the top wall 141 of the tank 102. In embodiments, a gasket 666 may be arranged on/around the fastener 664 to help seal the blind hole (that is at least partially defined by the upper bore 704 of the insert 662) at the exterior surface 140. In embodiments, the gasket 666 is an oil resistant neoprene rubber sealing washer that ensures no fluid/fuel would leak out of the blind hole in the event a leak were to develop there.

As previously mentioned, the (downstream) tank holder 550 and the upstream tank holder 660 may be formed in the same molding step as the tank 102, such that the inserts 640, 662 are at least partially encapsulated in the material 602. However, prior to performing such molding step, the internal venting conduit 302 may be arranged within the inserts 640, 662, such that the internal venting conduit 302 is also arranged within the molds prior to performing the molding step. Stated differently, the internal venting conduit 602 may first be arranged within the inserts 640, 662 and then the inserts may be attached within the mold (as detailed above), and then the material 602 may be injected into the molds to form the tank 102 and at least partially encapsulate/cover the inserts 640, 662. Thus, the tank 102 may be formed with the internal venting conduit 302 extending through the interior volume and up through the neck 104 of the tank 102. Then, the installer may utilize the opening 125 as an access point to continue assembly of the system 100. For example, after formation of the tank 102 with the (downstream) tank holder 550 and the upstream tank holder 660 attached therein and with the internal venting conduit 302 extending through the inserts 640, 662, and before installation of the sensor 124 in the opening 125 (i.e., the sensor 124 is removed or not yet installed), the installer may attach the clip 520 (which is already attached to the conduit 502, to the shutoff valve 500, and to the assembly 120 via the conduit 502) to the internal venting conduit 302 such that the conduit 520 and the shutoff valve 500 are supported by the internal venting conduit 302. Then, the installer may install the sensor 124 to the tank 102 at the opening 125 and thereby seal the opening 125 closed. Running the internal venting conduit 302 and the conduit 520 inside the interior volume of the tank 102 in this manner, and further supporting the conduits 302 and 520 from inside the tank 102, reduces the number of holes/openings formed in the tank 102 and also helps protects the conduits 302 and 520 from damage that may otherwise occur if they were positioned and secured on an outside/exterior of the tank 102, which in turn helps to reduce the potential for leaks and decrease the number of potential leak points on the system 100.

FIG. 7 also depicts how the internal venting conduit 302 extends into the first venting channel 220 of the assembly 120 to thereby permit venting of air or gas fumes out of the upper opening 430a of the first venting channel 220. When the adapter 110 is arrange don the neck 104 to thereby retain the assembly 120 within the neck, the upper opening 430a is exposed such that air or gas fumes entering the first venting conduit 220 from the internal venting conduit 302, may travel through the internal venting conduit and exit the assembly 120 via the upper opening 430a, as indicated by dashed arrow 714. Also, while the second venting channel 222 is not illustrated in this figure, the upper opening 432a of the second venting channel 222 is positioned next to the upper opening 430a of the first venting channel 220, as shown in FIG. 4A, such that the upper opening 432a similarly allows air or gas fumes entering the second venting conduit 222 (via the window 226), to travel through the upper portion 224a of the second venting channel 222 to exit the second venting channel 222 at the upper opening 432a thereof. Thus, both the upper openings 430a, 432a of the first and second venting channels 220, 222 are exposed when the adapter 110 is installed to allow air or gas fumes to exit the top end 208a of the assembly 120. Also depicted in the example of FIG. 7, the cap 112 is configured such that a tortuous path 720 is defined in the cap 112 that connects an inside 722 of the cap 112 and an outside 724 of the cap 112. The tortuous path 720 permits the air or gas exiting the assembly 120 to flow through the cap 112 while inhibiting any fluid/fuel to flow through the cap 112, thereby permitting venting of gases while inhibiting leaking of fluids. In this manner, air or gas fumes exiting the assembly 120 may exit (i.e., be vented from) the system 100 when the cap 112 is installed on the adapter 110. However, it should be appreciated that the cap 112 and/or the adapter 110 may be differently configured to permit venting out of the cap 112 and/or the adapter 110 when installed.

Also disclosed herein are methods involving the system 100 and the assembly 120 thereof. Disclosed herein, for example, is a method of assembling/manufacturing the assembly 120, a method of installing the assembly 120 within the tank 102, and a method of assembling/manufacturing the system 100.

In embodiments, the method of assembling the assembly 120 includes providing the sleeve 202, and both installing the venturi sub-assembly 400 in the central bore 206 of the sleeve 202 and installing the receiver 204 in the central bore 206 of the sleeve 202. The installing of the venturi sub-assembly 400 may include inserting the lower end 408b of the body 402 (of the venturi sub-assembly 400) in the upper end 266a of the lower conduit 262, such that the passageway 406 of the body 402 is in communication with and alignment with the inner passageway 280 of the lower conduit 262, and securing or attaching the receiver 204 to the sleeve 202 via the rivet 480. The receiver 204 may be installed on the sleeve 202 before installation of the venturi sub-assembly 400, or vice versa. The method also includes installing the float 230 in the second venting channel 222, wherein the second venting channel 222 extends through the sleeve 202 from the top end 208a towards the bottom end 208b; and installing the float 230 in the second channel 222 may further include securing the float 230 in the second channel 222 via the float cap 240 that is inserted into the bottom opening 224b and retained in the bottom opening 224b via the rivet 242. In addition, the method may also include installing the check valve 210 on the sleeve 202.

In embodiments, the method of installing the assembly 120 in the tank 102 includes connecting the conduit 502 to both the lower conduit 262 of the assembly 120 and the shutoff valve 500, and then inserting the conduit 502 and the shutoff valve 500 inside the tank 102 through the neck 104. The method may then include accessing the shutoff valve 500 and/or the conduit 502 via the opening 125 and then securing the conduit 502 and the shutoff valve 500 to the internal venting conduit 302 by snapping the clip 520 onto the internal venting conduit 302. The snapping of the clip 520 onto the internal venting conduit 302 may first include accessing the accessing the shutoff valve 500 and/or the conduit 502, as well as the internal venting conduit 302, through the opening 125 and by reaching through the opening 125 to place the clip 520 onto the internal venting conduit 302. Then, the method may include inserting the assembly 120 into the neck 104 of the tank and connecting the internal venting conduit 302 to the first venting channel 220. The method may then include mounting the adapter 110 on the neck 104 to thereby secure the assembly 120 to the tank 102, and then mounting the cap 112 to the adapter 110.

In embodiments, the method of assembling the system 100 includes forming the tank 102 with the internal venting conduit 302 extending up through the neck 104 of the tank 102. The step of forming the tank 102 may include attaching the insert 640 (and/or the insert 662) within/inside a mold via a bolt, and then injecting the material 602 into the mold to form the tank 102 and to at least partially encapsulate the inserts 640, 662. In this manner, the inserts 640, 662 are molded into the tank 102 to thereby form the downstream and upstream tube holders 550, 660. Before or after forming the tank 102 with the internal venting conduit 302 supported therein, the method of assembly the system 100 may include inserting/screwing a set screw into the lower bore 704 of the insert 662 of the upstream tube holder 660 to secure the internal venting conduit 302 therein and/or welding the internal venting conduit 302 within the bore 702 of the upstream tube holder 660.

The method of assembling the system 100 may further include removing the bolts from the inserts 640, 662 which were utilized for retaining the inserts 640, 662 to the mold, removing the tank 102 from the mold. The method of assembly the system 100 may also include inserting/screwing the fastener 560 into the blind hole 645 to further strengthen the attachment of the insert 640 to the tank 102 and/or inserting/screwing the fastener 664 into the blind hole associated with the upper bore 704 to further strengthen the attachment of the insert 662 to the top wall 141 of the tank 102. The method of assembling the system 100 may also include connecting the conduit 502 to the shutoff valve 500 and then inserting the shutoff valve 500 into the interior volume of the tank 102 via the neck 104. In embodiments, the assembly 120 is also connected to the conduit 502 prior to inserting the shutoff valve 500 into the interior volume of the tank 102; however, the assembly 120 may remain unconnected to the conduit 502 until later in the method.

The method of assembling the system 100 may also include attaching the clip 520 of the shutoff valve 500 to the internal venting conduit 302, such that the internal venting conduit 302 and the inserts 640, 662 support the shutoff valve 500 inside of the tank 102 and couple the shutoff valve 500 to the interior of the tank 102. The method of assembling the system 100 may also include connecting the conduit 502 to the direct fill assembly 120, wherein the distal end 526 of the conduit 502 is connected to the shutoff valve 500 and the proximal end 505 of the conduit 502 is connected to the lower conduit 262 of the direct fill assembly 120, and wherein the lower conduit 262 of the direct fill assembly 120 is operatively connected to the venturi sub-assembly 400. Then, the method of assembling the system 100 may include inserting/arranging the direct fill assembly 120 into the neck 104 of the tank 102 and connecting the proximal end 307 of the internal venting conduit 302 to the first venting channel 220 of the direct fill assembly 120. The method of assembling the system 100 may further include attaching the adapter 110 to the neck 104 of the tank 102 to thereby secure the direct fill assembly 120 within the neck 104, and attaching the cap 112 to the adapter 110, wherein the cap 112 is configured to permit venting of air or gas fumes through the cap 112, for example, via the tortuous path 720 defined in the cap 112. In embodiments, the method of assembling the system 100 may further include applying the low friction sleeve 642 to portions of the internal venting conduit 302 that extend through the insert 640 and/or the upstream insert 662 prior to arranging the internal venting conduit 302 within the inserts 640, 662 and before forming the tank 102.

Embodiments disclosed herein include:
A. A fuel system, comprising: a tank defining an interior volume, the tank having a neck with an opening in the neck through which the interior volume is accessible; and a direct fill assembly inserted into the neck of the tank, the direct fill assembly having an upper end and a lower end, wherein the direct fill assembly includes a first venting channel and a second venting channel, the second venting channel extending between the lower end and the upper end and venting gas accumulating proximate to the lower end, the first venting channel connected to an internal venting conduit that extends through the neck and the interior volume of the tank and provides venting from a distal end of the internal venting conduit.
B. A method of manufacturing a fuel tank system, comprising: forming a tank with at least one tube holder arranged inside the tank and with an internal venting conduit that extends through a neck of the tank and through the at least one tube holder; connecting a distal end of a conduit to a shutoff valve; inserting the shutoff valve through the neck and into the tank; attaching a clip of the shutoff valve to the internal venting conduit, such that the internal venting conduit and the at least one tube holder support the shutoff valve inside of the tank and couple the shutoff valve to the interior of the tank; and arranging the direct fill assembly in the neck of the tank and connecting a proximal end of the internal venting conduit to a first venting channel of the direct fill assembly, wherein: the direct fill assembly includes an upper end, a lower end, a first venting channel, and a second venting channel, the second venting channel extending between the lower end and the upper end and venting gas accumulating proximate to the lower end, the first venting channel connected to the internal venting conduit that extends through the interior volume of the tank and venting from a distal end of the internal venting conduit.
C. A method of assembling a direct fill assembly, comprising: providing a sleeve of the direct fill assembly and a receiver of the direct fill assembly; installing a venturi sub-assembly in a central bore of the sleeve and installing the receiver in the central bore of the sleeve, wherein the installing the venturi sub-assembly further comprises: inserting a lower end of the venturi sub-assembly in an upper end of a lower conduit of the sleeve, such that a passageway extending through a body of the venturi sub-assembly is in communication with and alignment with an inner passageway of the lower conduit; installing a fluid limiting float valve in the second venting channel, wherein the second venting channel extends through the sleeve from a top end towards a bottom end, and wherein the installing the fluid limiting float valve in the second venting channel further comprises securing a float in the second channel via a float cap that is inserted into a bottom opening of the second venting channel and retained in the bottom opening via a rivet; installing a check valve on the bottom end of the sleeve; and securing the receiver to the sleeve via a rivet.

Each of embodiments A through C may have one or more of the following additional elements in any combination:

Element 1: further comprising a venturi sub-assembly configured to automatically shut off input of fluid into the direct fill assembly. Element 2: wherein the venturi sub-assembly includes a shutoff valve supported within the tank by the internal venting conduit. Element 3: wherein the shutoff valve is coupled to the internal venting conduit via a clip. Element 4: wherein the clip is attached to the internal venting conduit, and the internal venting conduit is supported within the interior volume of the tank via a tube holder. Element 5: wherein the internal venting conduit extends through the tube holder. Element 6:, wherein tube holder comprises a metallic insert and a plastic material overmolded onto and encapsulating the metallic insert. Element 7: wherein the tube holder is a downstream tube holder, further comprising an upstream tube holder that supports the internal venting conduit within the interior volume of the tank, wherein the upstream tube holder comprises an upstream metallic insert and the plastic overmolded onto and encapsulating the upstream metallic insert. Element 8: wherein the direct fill assembly is removable from the neck of the tank. Element 9: wherein the direct fill assembly includes a flap valve movable between a closed position and an open position, the flap valve is biased in the closed position. Element 10: wherein the direct fill assembly includes a fluid limiting float valve slidably disposed in the second venting channel. Element 11: wherein the connecting the distal end of the conduit to the shutoff valve further comprises connecting a proximal end of the conduit to a lower conduit of the direct fill assembly, wherein the lower conduit of the direct fill assembly is operatively connected to a venturi sub-assembly that is configured to automatically shut off input of fluid into the direct fill assembly. Element 12: wherein the at least one tank holder includes a downstream tank holder and an upstream tank holder, and the method further includes securing the internal venting conduit in the upstream tank holder via a set screw. Element 13: further comprising: attaching an adapter to the neck of the tank to thereby secure the direct fill assembly within the neck; and attaching a cap to the adapter. Element 14: further comprising assembling the direct fill assembly. Element 15: wherein assembling of the direct fill assembly further comprises: providing a sleeve of the direct fill assembly and a receiver of the direct fill assembly; installing a venturi sub-assembly in a central bore of the sleeve and installing the receiver in the central bore of the sleeve, wherein the venturi sub-assembly is configured to automatically shut off input of fluid into the direct fill assembly; installing a fluid limiting float valve in the second venting channel, wherein the second venting channel extends through the sleeve from the top end towards the bottom end; and installing a check valve on the sleeve. Element 16: wherein the installing the fluid limiting float valve in the second venting channel further comprises securing a float in the second channel via a float cap that is inserted into a bottom opening of the second venting channel and retained in the bottom opening via a rivet. Element 17: wherein the installing the venturi sub-assembly further comprises: inserting a lower end of the venturi sub-assembly in an upper end of a lower conduit of the sleeve, such that a passageway extending through a body of the venturi sub-assembly is in communication with and alignment with an inner passageway of the lower conduit, and securing the receiver to the sleeve via a rivet.

By way of non-limiting example, exemplary combinations applicable to A through C include: Element 2 with Element 1; Element 3 with Element 2; Element 4 with Element 3; Element 5 with Element 4; Element 6 with Element 4; Element 7 with Element 4; Element 8 with Element 4; Element 15 with Element 14; Element 16 with Element 15; and Element 17 with Element 15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A fuel system, comprising:
a tank defining an interior volume, the tank having a neck with an opening in the neck through which the interior volume is accessible; and
a direct fill assembly inserted into the neck of the tank, the direct fill assembly having an upper end and a lower end, wherein the direct fill assembly includes a first venting channel and a second venting channel, the second venting channel extending between the lower end and the upper end and venting gas accumulating proximate to the lower end, the first venting channel connected to an internal venting conduit that extends through the neck and the interior volume of the tank and provides venting from a distal end of the internal venting conduit.

2. The fuel system of claim 1, further comprising a venturi sub-assembly configured to automatically shut off input of fluid into the direct fill assembly.

3. The fuel system of claim 2, wherein the venturi sub-assembly includes a shutoff valve supported within the tank by the internal venting conduit.

4. The fuel system of claim 3, wherein the shutoff valve is coupled to the internal venting conduit via a clip.

5. The fuel system of claim 4, wherein the clip is attached to the internal venting conduit, and the internal venting conduit is supported within the interior volume of the tank via a tube holder.

6. The fuel system of claim 5, wherein the internal venting conduit extends through the tube holder.

7. The fuel system of claim 5, wherein tube holder comprises a metallic insert and a plastic material overmolded onto and encapsulating the metallic insert.

8. The fuel system of claim 5, wherein the tube holder is a downstream tube holder, further comprising an upstream tube holder that supports the internal venting conduit within the interior volume of the tank, wherein the upstream tube holder comprises an upstream metallic insert and the plastic overmolded onto and encapsulating the upstream metallic insert.

9. The fuel system of claim 1, wherein the direct fill assembly is removable from the neck of the tank.

10. The fuel system of claim 1, wherein the direct fill assembly includes a flap valve movable between a closed position and an open position, the flap valve is biased in the closed position.

11. The fuel system of claim 1, wherein the direct fill assembly includes a fluid limiting float valve slidably disposed in the second venting channel.

12. A method of manufacturing a fuel tank system, comprising:
forming a tank with at least one tube holder arranged inside the tank and with an internal venting conduit that extends through a neck of the tank and through the at least one tube holder;
connecting a distal end of a conduit to a shutoff valve;
inserting the shutoff valve through the neck and into the tank;
attaching a clip of the shutoff valve to the internal venting conduit, such that the internal venting conduit and the at least one tube holder support the shutoff valve inside of the tank and couple the shutoff valve to the interior of the tank; and
arranging the direct fill assembly in the neck of the tank and connecting a proximal end of the internal venting conduit to a first venting channel of the direct fill assembly, wherein:
the direct fill assembly includes an upper end, a lower end, a first venting channel, and a second venting channel, the second venting channel extending between the lower end and the upper end and venting gas accumulating proximate to the lower end, the first venting channel connected to the internal venting conduit that extends through the interior volume of the tank and venting from a distal end of the internal venting conduit.

13. The method of claim 12, wherein the connecting the distal end of the conduit to the shutoff valve further comprises connecting a proximal end of the conduit to a lower conduit of the direct fill assembly, wherein the lower conduit of the direct fill assembly is operatively connected to a venturi sub-assembly that is configured to automatically shut off input of fluid into the direct fill assembly.

14. The method of claim 12, wherein the at least one tank holder includes a downstream tank holder and an upstream tank holder, and the method further includes securing the internal venting conduit in the upstream tank holder via a set screw.

15. The method of claim 12, further comprising:
attaching an adapter to the neck of the tank to thereby secure the direct fill assembly within the neck; and
attaching a cap to the adapter.

16. The method of claim 12, further comprising assembling the direct fill assembly.

17. The method of claim 16, wherein assembling of the direct fill assembly further comprises:
providing a sleeve of the direct fill assembly and a receiver of the direct fill assembly;
installing a venturi sub-assembly in a central bore of the sleeve and installing the receiver in the central bore of the sleeve, wherein the venturi sub-assembly is configured to automatically shut off input of fluid into the direct fill assembly;
installing a fluid limiting float valve in the second venting channel, wherein the second venting channel extends through the sleeve from the top end towards the bottom end; and
installing a check valve on the sleeve.

18. The method of claim 17, wherein the installing the fluid limiting float valve in the second venting channel further comprises securing a float in the second channel via a float cap that is inserted into a bottom opening of the second venting channel and retained in the bottom opening via a rivet.

19. The method of claim 17, wherein the installing the venturi sub-assembly further comprises:
inserting a lower end of the venturi sub-assembly in an upper end of a lower conduit of the sleeve, such that a passageway extending through a body of the venturi sub-assembly is in communication with and alignment with an inner passageway of the lower conduit, and
securing the receiver to the sleeve via a rivet.

20. A method of assembling a direct fill assembly, comprising:
providing a sleeve of the direct fill assembly and a receiver of the direct fill assembly;
installing a venturi sub-assembly in a central bore of the sleeve and installing the receiver in the central bore of the sleeve, wherein the installing the venturi sub-assembly further comprises:
inserting a lower end of the venturi sub-assembly in an upper end of a lower conduit of the sleeve, such that a passageway extending through a body of the venturi sub-assembly is in communication with and alignment with an inner passageway of the lower conduit;
installing a fluid limiting float valve in the second venting channel, wherein the second venting channel extends through the sleeve from a top end towards a bottom end, and wherein the installing the fluid limiting float valve in the second venting channel further comprises securing a float in the second channel via a float cap that is inserted into a bottom opening of the second venting channel and retained in the bottom opening via a rivet;
installing a check valve on the bottom end of the sleeve; and
securing the receiver to the sleeve via a rivet.
